(19) United States
(12) Patent Application Publication
(10) Pub. No.: US 2022/0271821 A1
(43) Pub. Date: Aug. 25, 2022

(54) METHOD AND APPARATUS FOR SIGNALING OF INTER-CELL BEAM MANAGEMENT

(71) Applicant: Samsung Electronics Co., Ltd., Suwon-si (KR)

(72) Inventors: Emad N. Farag, Flanders, NJ (US); Eko Onggosanusi, Coppell, TX (US); Dalin Zhu, Richardson, TX (US)

(21) Appl. No.: 17/651,376

(22) Filed: Feb. 16, 2022

Related U.S. Application Data
(60) Provisional application No. 63/152,812, filed on Feb. 23, 2021.
(60) Provisional application No. 63/271,555, filed on Oct. 25, 2021.
(60) Provisional application No. 63/276,339, filed on Nov. 5, 2021.
(60) Provisional application No. 63/297,085, filed on Jan. 6, 2022.

(51) Int. Cl. H04B 7/08; H04W 72/12; H04L 5/00

(52) U.S. Cl. CPC H04B 7/088; H04W 72/1289; H04L 5/0051

(57) ABSTRACT

Methods and apparatuses for signaling of inter-cell beam management in a wireless communication system. A method of operating a user equipment includes receiving configuration information for a list of transmission configuration indication (TCI) states; receiving an indication of activated TCI state code points via a medium access control-control element (MAC CE); and receiving a downlink control information (DCI) indicating an activated TCI state code point. The method further includes determining a TCI state to apply based on the activated TCI state code point; determining an entity of the TCI state and a source reference signal (RS) of the TCI state; updating spatial filters for downlink (DL) channels or uplink (UL) channels based on the source RS and entity; and receiving or transmitting the DL channels or the UL channels of the entity, respectively, based on the updated spatial filters.

### CROSS-REFERENCE TO RELATED APPLICATIONS AND CLAIM OF PRIORITY

The present application claims priority to:
U.S. Provisional Patent Application No. 63/152,812, filed on Feb. 23, 2021;
U.S. Provisional Patent Application No. 63/271,555, filed on Oct. 25, 2021;
U.S. Provisional Patent Application No. 63/276,339, filed on Nov. 5, 2021; and
U.S. Provisional Patent Application No. 63/297,085, filed on Jan. 6, 2022. The content of the above-identified patent document is incorporated herein by reference.

### TECHNICAL FIELD

The present disclosure relates generally to wireless communication systems and, more specifically, the present disclosure relates to a signaling of inter-cell beam management in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a signaling of inter-cell beam management in a wireless communication system.

In one embodiment, a user equipment (UE) is provided. The UE includes a transceiver configured to: receive or transmit on K>1 entities, receive configuration information for a first list of reference signals (RSs); wherein a RS in the first list is identified by an index within an entity and an index or identifier of the entity; receive configuration information for a second list of RSs, wherein a RS in the second list is identified by a common index across the K>1 entities; receive configuration information for a list of transmission configuration indication (TCI) states, wherein a source RS of a TCI state in the list of TCI states is from the first list of RSs or the second list of RSs; receive an indication of activated TCI state code points via a medium access control-control element (MAC CE); and receive a downlink control information (DCI) indicating at least one of the activated TCI state code points. The UE further includes a processor operably coupled to the transceiver. The processor is configured to: determine a TCI state to apply based on the at least one activated TCI state code point indicated by the DCI, determine an entity of the determined TCI state and a source RS of the determined TCI state, and update spatial filters for downlink (DL) channels or uplink (UL) channels based on the determined source RS. The transceiver is further configured to receive or transmit the DL channels or the UL channels of the determined entity, respectively, based on the updated spatial filters.

In another embodiment, a base station (BS) is provided. The BS includes a transceiver configured to: receive or transmit on K>1 entities; transmit configuration information for a first list of RSs, wherein a RS in the first list is identified by an index within an entity and an index or identifier of the entity; transmit configuration information for a second list of RSs, wherein a RS in the second list is identified by a common index across the K>1 entities; transmit configuration information for a list of TCI states, wherein a source RS of a TCI state in the list of TCI states is from the first list of RSs or the second list of RSs; transmit an indication of activated TCI state code points via a MAC CE. The BS further includes a processor operably coupled to the transceiver. The processor is configured to determine a source RS and an associated entity to be signaled and determine a TCI state code point to apply based on the determined source RS and the associated entity from the at least one activated TCI state code points. The transceiver is further configured to transmit a DCI indicating the determined TCI state code point. The processor is further configured to update spatial filters for DL channels or UL channels based on the determined source RS. The transceiver is further configured to transmit or receive the DL channels and the UL channels of the associated entity, respectively, based on the updated spatial filters.

In yet another embodiment, a method of operating a UE is provided. The method includes receiving configuration information to receive or transmit on K>1 entities; receiving configuration information for a first list of RSs, wherein a RS in the first list is identified by an index within an entity and an index or identifier of the entity; receiving configuration information for a second list of RSs, wherein a RS in the second list is identified by a common index across the K>1 entities; receiving configuration information for a list of TCI states, wherein a source RS of a TCI state in the list of TCI states is from the first list of RSs or the second list of RSs; receiving an indication of activated TCI state code points via a MAC CE; and receiving a DCI indicating at least one of the activated TCI state code points. The method further includes determining a TCI state to apply based on the at least one activated TCI state code point indicated by the DCI; determining an entity of the determined TCI state and a source RS of the determined TCI state; updating spatial filters for DL channels or UL channels based on the determined source RS; and receiving or transmitting the DL channels or the UL channels of the determined entity, respectively, based on the updated spatial filters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrate an example of wireless system beam according to embodiments of the present disclosure;

FIG. 6B illustrate an example of multi-beam operation according to embodiments of the present disclosure;

FIG. 7 illustrate an example of antenna structure according to embodiments of the present disclosure;

FIG. 8 illustrates an example of DL multi beam operation according to embodiments of the present disclosure;

FIG. 9 illustrates an example of DL multi beam operation according to embodiments of the present disclosure;

FIG. 10 illustrates an example of UL multi beam operation according to embodiments of the present disclosure;

FIG. 11 illustrates an example of UL multi beam operation according to embodiments of the present disclosure;

FIG. 12 illustrates an example of TCI state configuration associated with a TCI state ID according to embodiments of the present disclosure;

FIG. 13 illustrates an example of two sets of activated TCI state IDs according to embodiments of the present disclosure;

FIG. 14 illustrates an example of three sets of activated TCI state IDs according to embodiments of the present disclosure;

FIG. 15 illustrates an example of two sets of activated TCI state IDs according to embodiments of the present disclosure;

FIG. 16 illustrates an example of a set of activated TCI state IDs according to embodiments of the present disclosure;

FIG. 17 illustrates an example of a set of activated TCI state IDs according to embodiments of the present disclosure;

FIG. 18 illustrates an example of a first set of TCI state IDs for a first cell or a first group of cells according to embodiments of the present disclosure;

FIG. 19 illustrates another example of a first set of TCI state IDs for a first cell or a first group of cells according to embodiments of the present disclosure;

FIG. 20 illustrates a flowchart of method for C-RNTI checking operation according to embodiments of the present disclosure;

FIG. 21 illustrates an example of configuration of entity according to embodiments of the present disclosure;

FIG. 22 illustrates an example of RS list in a common pool across all entities according to embodiments of the present disclosure;

FIG. 23 illustrates an example of QCL/Source RS relations according to embodiments of the present disclosure;

FIG. 24 illustrates an example of SSB-Index-PCI according to embodiments of the present disclosure;

FIG. 25 illustrates an example of NZP-CSI-RS-ResourceId-PCI according to embodiments of the present disclosure;

FIG. 26 illustrates an example of SRS-Resource ID according to embodiments of the present disclosure;

FIG. 27 illustrates an example of entity configuration according to embodiments of the present disclosure;

FIG. 28 illustrates an example of SSB-Index-Entity-Index according to embodiments of the present disclosure;

FIG. 29 illustrates an example of NZP-CSI-RS-ResourceId-Entity-Index according to embodiments of the present disclosure;

FIG. 30 illustrates an example of SRS-ResourcedId-Entity-Index according to embodiments of the present disclosure;

FIG. 31 illustrates an example of entity configuration according to embodiments of the present disclosure;

FIG. 32 illustrates an example of SSB-Index-Entity-Index according to embodiments of the present disclosure;

FIG. 33 illustrates an example of NZP-CSI-RS-ResourceId-Entity-Index according to embodiments of the present disclosure;

FIG. 34 illustrates an example of SRS-ResourcedId-Entity-Index according to embodiments of the present disclosure;

FIG. 35 illustrates an example of QCL-Info according to embodiments of the present disclosure;

FIG. 36 illustrates another example of QCL-Info according to embodiments of the present disclosure;

FIG. 37 illustrates yet another example of QCL-Info according to embodiments of the present disclosure;

FIG. 38 illustrates yet another example of QCL-Info according to embodiments of the present disclosure;

FIG. 39 illustrates an example of TCI states/TCI stat IDs for K groups according to embodiments of the present disclosure;

FIG. 40 illustrates an example of TCI states/TCI stat IDs for a common pool across all entities according to embodiments of the present disclosure;

FIG. 41 illustrates an example of entity index for the reference signal according to embodiments of the present disclosure;

FIG. 42 illustrates another example of entity index for the reference signal according to embodiments of the present disclosure;

FIG. 43 illustrates an example of MAC CE activation message according to embodiments of the present disclosure;

FIG. 44 illustrates another example of MAC CE activation message according to embodiments of the present disclosure;

FIG. 45 illustrates yet another example of MAC CE activation message according to embodiments of the present disclosure; and

FIG. 46 illustrates yet another example of MAC CE activation message according to embodiments of the present disclosure.

### DETAILED DESCRIPTION

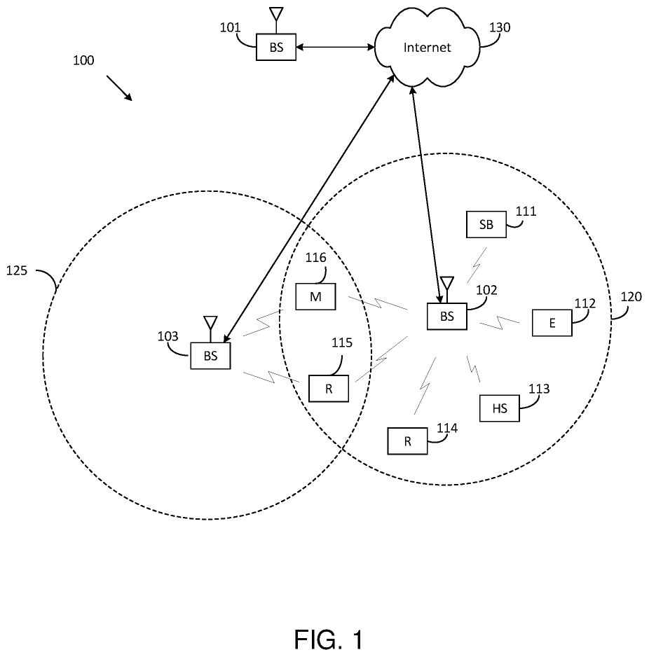

FIG. 1 through FIG. 46, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.8.0, “NR; Physical channels and modulation”; 3GPP TS 38.212 v16.8.0, “NR; Multiplexing and Channel coding”; 3GPP TS 38.213 v16.8.0, “NR; Physical Layer Procedures for Control”; 3GPP TS 38.214 v16.8.0, “NR; Physical Layer Procedures for Data”; 3GPP TS 38.321 v16.7.0, “NR; Medium Access Control (MAC) protocol specification”; and 3GPP TS 38.331 v16.7.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for signaling of inter-cell beam management in a wireless communication system. In certain embodiments, and one or more of the gNBs 101-103 includes circuitry, programing, or a combination thereof, for signaling of inter-cell beam management in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

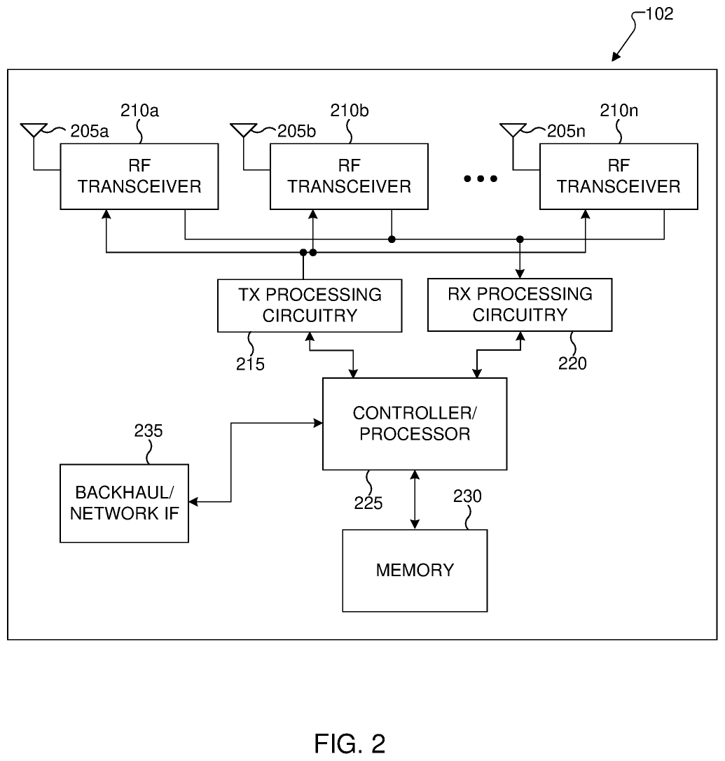

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support signaling of inter-cell beam management in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

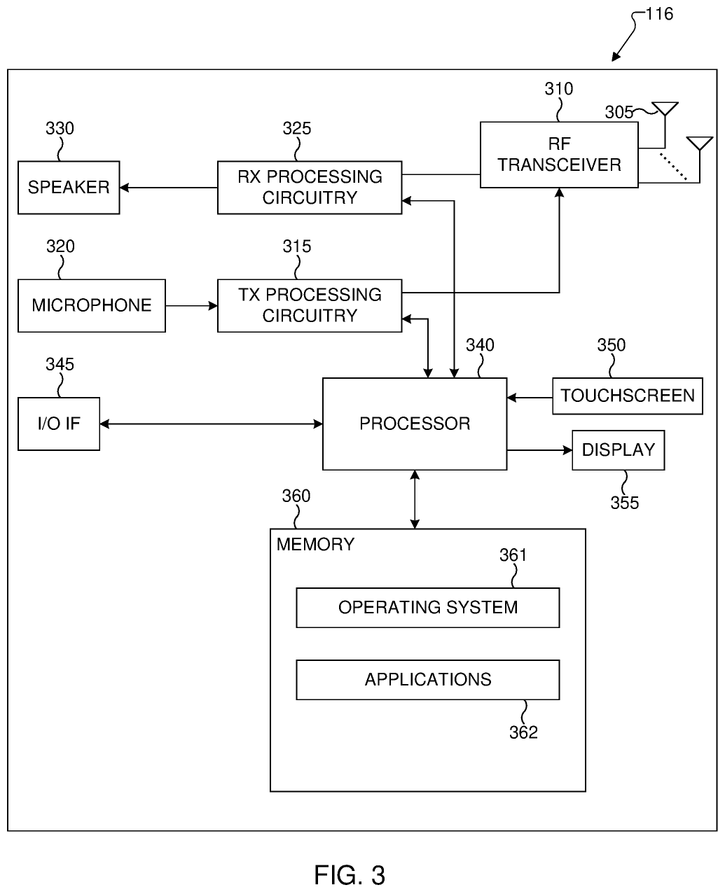

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for signaling of inter-cell beam management in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

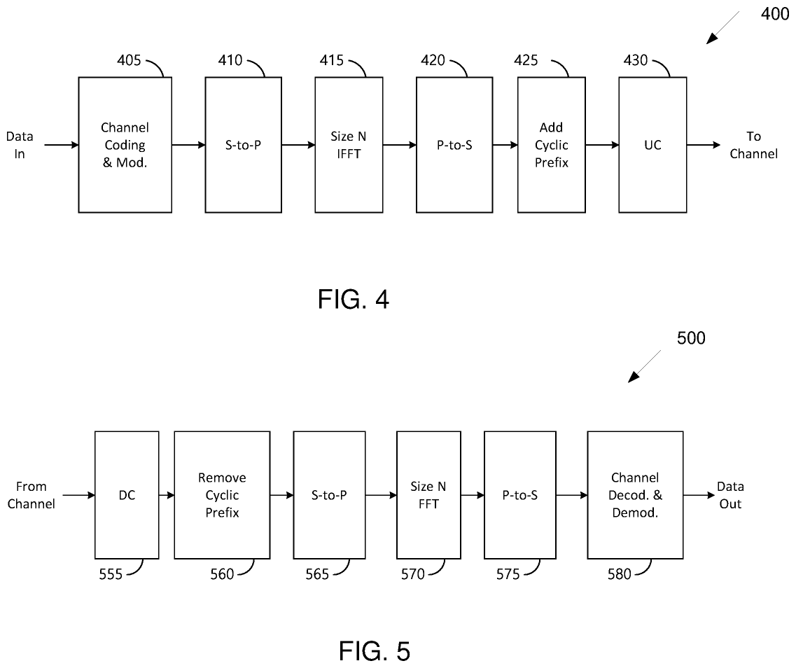

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Rel-17 introduced the unified TCI framework, where a unified or master or main TCI state is signaled or indicated to the UE. The unified or master or main or indicated TCI state can be one of:
1. In case of joint TCI state indication, where a same beam is used for DL and UL channels, a joint TCI state that can be used at least for UE-dedicated DL channels and UE-dedicated UL channels.
2. In case of separate TCI state indication, where different beams are used for DL and UL channels, a DL TCI state can be used at least for UE-dedicated DL channels.
3. In case of separate TCI state indication, where different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

In this disclosure, a beam is determined by either of: a TCI state, that establishes a quasi-colocation (QCL) relationship between a source reference signal (e.g., SSB and/or CSI-RS) and a target reference signal; or a spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

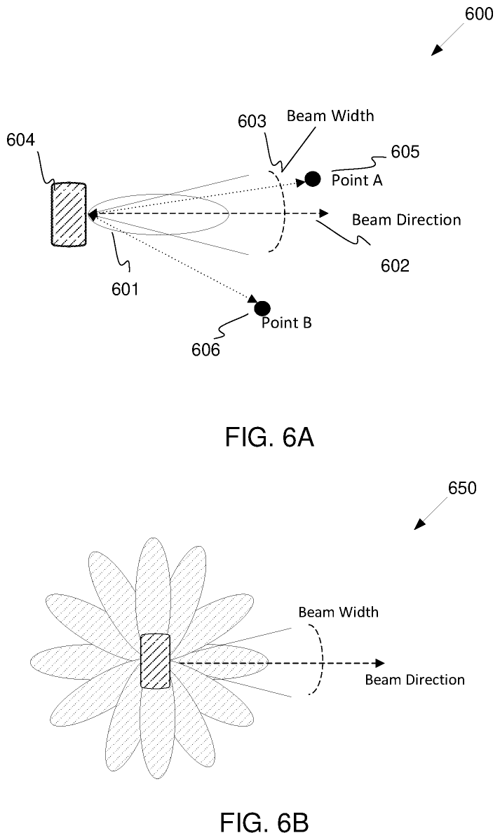

FIG. 6A illustrate an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrate an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

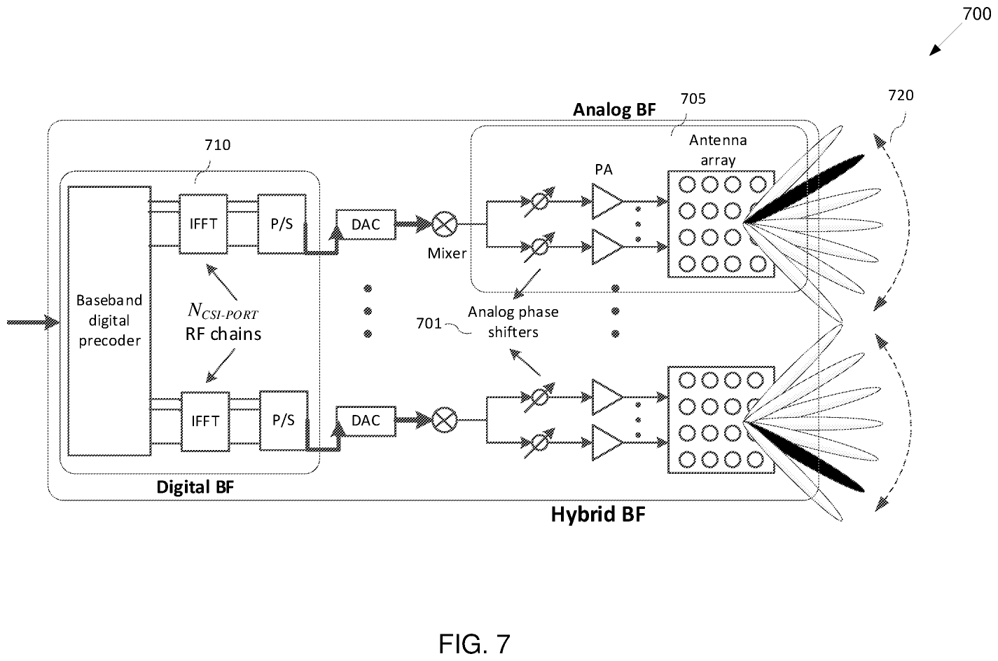

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrate an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

As described in U.S. patent application Ser. No. 17/148,517, filed Jan. 13, 2021, which is incorporated by reference herein, a TCI DCI can be a dedicated channel for beam indication information, i.e., a purposed designed DL channel for beam indication. Beam indication information can also be included in a DL-related DCI (with DL assignment or without DL assignment) or in an UL-related DCI (with UL grant or without UL grant). In this disclosure, more detailed signaling aspects is provided for inter-cell beam management, including the activation and indication of TCI states for non-serving cells and signaling of C-RNTI for non-serving cells.

The present disclosure provides more detailed aspects related to the configuration and signaling of beam indication relaying on L1 signaling as well as higher layer configuration and signaling.

In release 15/16 a common framework is shared for CSI and beam management, while the complexity of such framework is justified for CSI in FR1, it makes beam management procedures rather cumbersome, and less efficient in FR2. Efficiency here refers to overhead associated with beam management operations and latency for reporting and indicating new beams.

Furthermore, in release 15 and release 16, the beam management framework is different for different channels. This increases the overhead of beam management, and could lead to less robust beam-based operation. For example, for PDCCH the TCI state (used for beam indication), is updated through MAC CE signaling. While the TCI state of PDSCH can be updated through a DL DCI carrying the DL assignment with codepoints configured by MAC CE, or the PDSCH TCI state can follow that of the corresponding PDCCH, or use a default beam indication. In the uplink direction, the spatialRelationInfo framework is used for beam indication for PUCCH and SRS, which is updated through RRC and MAC CE signaling. For PUSCH the SRI (SRS Resource Indicator), in an UL DCI with UL grants, can be used for beam indication. Having different beam indications and beam indication update mechanisms increases the complexity, overhead and latency of beam management, and could lead to less robust beam-based operation.

For inter-cell mobility, L3-based handover suffers increased overhead due to L3 messages, and higher latency due to the involvement of L3 in the handover process. To streamline the handover process and reduce its overhead and latency L1/L2 centric handover can be utilized, wherein a network indicates to the UE a beam of a non-serving cell (e.g., a cell with a PCI different from the PCI of the serving cell) using a channel that conveys a TCI state ID (e.g., a TCI state code point). The present disclosure provides detailed signaling aspects for Inter-Cell beam management, including the activation and indication of TCI states for non-serving cells and signaling of C-RNTI for non-serving cells.

For inter-cell mobility, L3-based handover suffers increased overhead due to L3 messages, and higher latency due to the involvement of L3 in the handover process. To streamline the handover process and reduce its overhead and latency L1/L2 centric handover, also known as inter-cell beam management, can be utilized, wherein a network indicates to the UE a beam of a non-serving cell (i.e., a cell with a PCI different from the PCI of the serving cell) using a channel that conveys a TCI state ID (e.g. TCI state code point). The present disclosure provides aspects related to the configuration of the TCI states and source RS for cells with PCI different from the PCI of the serving cell.

The present disclosure relates to a 5G/NR communication system.

The present disclosure considers design aspects for inter-cell beam management, including the activation and indication of TCI states for non-serving cells and signaling of C-RNTI for non-serving cells.

The present disclosure provides design aspects related to the configuration and signaling of TCI state IDs for cells with TCI states different from that of the serving cell and to facilitate inter-cell beam management.

The present disclosure builds on beam indication designs that are described, by way of example, U.S. patent application Ser. No. 17/444,556 filed Aug. 5, 2021, which is incorporated herein by reference in its entirety.

In the following, both FDD and TDD are considered as a duplex method for DL and UL signaling.

Although exemplary descriptions and embodiments to follow assume OFDM or OFDMA, the present disclosure can be extended to other OFDM-based transmission waveforms or multiple access schemes such as filtered OFDM (F-OFDM).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on. For instance, for DL, as the UE receives a reference RS index/ID, for example through a field in a DCI format, that is represented by a TCI state, the UE applies the known characteristics of the reference RS to associated DL reception. The reference RS can be received and measured by the UE (for example, the reference RS is a downlink signal such as NZP CSI-RS and/or SSB) and the UE can use the result of the measurement for calculating a beam report (in Rel-15 NR, a beam report includes at least one L1-RSRP accompanied by at least one CRI). Using the received beam report, the NW/gNB can assign a particular DL TX beam to the UE. A reference RS can also be transmitted by the UE (for example, the reference RS is an uplink signal such as SRS). As the NW/gNB receives the reference RS from the UE, the NW/gNB can measure and calculate information used to assign a particular DL TX beam to the UE. This option is applicable at least when there is DL-UL beam pair correspondence.

In another instance, for UL transmissions, a UE can receive a reference RS index/ID in a DCI format scheduling an UL transmission such as a PUSCH transmission and the UE then applies the known characteristics of the reference RS to the UL transmission. The reference RS can be received and measured by the UE (for example, the reference RS is a downlink signal such as NZP CSI-RS and/or SSB) and the UE can use the result of the measurement to calculate a beam report. The NW/gNB can use the beam report to assign a particular UL TX beam to the UE. This option is applicable at least when DL-UL beam pair correspondence holds. A reference RS can also be transmitted by the UE (for example, the reference RS is an uplink signal such as SRS or DMRS). The NW/gNB can use the received reference RS to measure and calculate information that the NW/gNB can use to assign a particular UL TX beam to the UE.

The reference RS can be triggered by the NW/gNB, for example via DCI in case of aperiodic (AP) RS, or can be configured with a certain time-domain behavior, such as a periodicity and offset in case of periodic RS, or can be a combination of such configuration and activation/deactivation in case of semi-persistent RS.

For mmWave bands (or FR2) or for higher frequency bands (such as >52.6 GHz) where multi-beam operation is especially relevant, a transmission-reception process includes a receiver selecting a receive (RX) beam for a given TX beam. For DL multi-beam operation, a UE selects a DL RX beam for every DL TX beam (that corresponds to a reference RS). Therefore, when DL RS, such as CSI-RS and/or SSB, is used as reference RS, the NW/gNB transmits the DL RS to the UE for the UE to be able to select a DL RX beam. In response, the UE measures the DL RS, and in the process selects a DL RX beam, and reports the beam metric associated with the quality of the DL RS.

In this case, the UE determines the TX-RX beam pair for every configured (DL) reference RS. Therefore, although this knowledge is unavailable to the NW/gNB, the UE, upon receiving a DL RS associated with a DL TX beam indication from the NW/gNB, can select the DL RX beam from the information the UE obtains on all the TX-RX beam pairs. Conversely, when an UL RS, such as an SRS and/or a DMRS, is used as reference RS, at least when DL-UL beam correspondence or reciprocity holds, the NW/gNB triggers or configures the UE to transmit the UL RS (for DL and by reciprocity, this corresponds to a DL RX beam). The gNB, upon receiving and measuring the UL RS, can select a DL TX beam. As a result, a TX-RX beam pair is derived. The NW/gNB can perform this operation for all the configured UL RSs, either per reference RS or by “beam sweeping”, and determine all TX-RX beam pairs associated with all the UL RSs configured to the UE to transmit.

The following two embodiments (A-1 and A-2) are examples of DL multi-beam operations that utilize DL-TCI-state based DL beam indication. In the first example embodiment (A-1), an aperiodic CSI-RS is transmitted by the NW/gNB and received/measured by the UE. This embodiment can be used regardless of whether or not there is UL-DL beam correspondence. In the second example embodiment (A-2), an aperiodic SRS is triggered by the NW and transmitted by the UE so that the NW (or a gNB) can measure the UL channel quality for the purpose of assigning a DL RX beam. This embodiment can be used at least when there is UL-DL beam correspondence. Although aperiodic RS is considered in the two examples, a periodic or a semi-persistent RS can also be used.

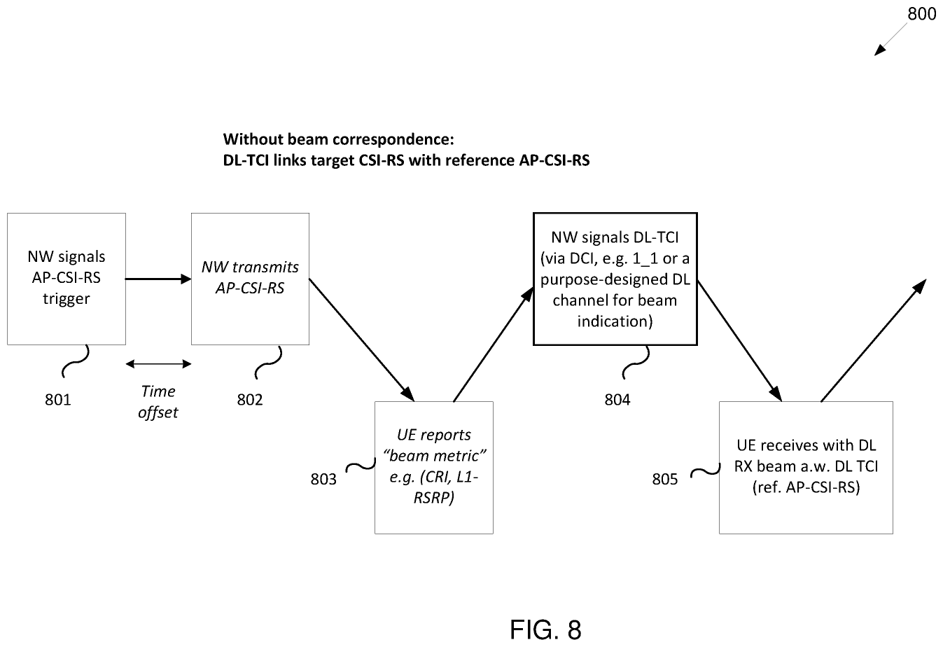

FIG. 8 illustrates an example of DL multi beam operation 800 according to embodiments of the present disclosure. An embodiment of the DL multi beam operation 800 shown in FIG. 8 is for illustration only.

In one example illustrated in FIG. 8 (embodiment A-1), a DL multi-beam operation 800 starts with the gNB/NW signaling to a UE an aperiodic CSI-RS (AP-CSI-RS) trigger or indication (step 801). This trigger or indication can be included in a DCI and indicate transmission of AP-CSI-RS in a same (zero time offset) or in a later slot/sub-frame (>0 time offset). For example, the DCI can be related to scheduling of a DL reception or an UL transmission and the CSI-RS trigger can be either jointly or separately coded with a CSI report trigger. Upon receiving the AP-CSI-RS transmitted by the gNB/NW (step 802), the UE measures the AP-CSI-RS and calculates and reports a “beam metric” that indicates a quality of a particular TX beam hypothesis (step 803). Examples of such beam reporting are a CSI-RS resource indicator (CRI), or a SSB resource indicator (SSB-RI), coupled with an associated L1-RSRP/L1-RSRQ/L1-SINR/CQI.

Upon receiving the beam report from the UE, the gNB/NW can use the beam report to select a DL RX beam for the UE and indicate the DL RX beam selection (step 804) using a TCI-state field in a DCI format such as a DCI format scheduling a PDSCH reception by the UE. In this case, a value of the TCI-state field indicates a reference RS, such as an AP-CSI-RS, representing the selected DL TX beam (by the gNB/NW). In addition, the TCI-state can also indicate a “target” RS, such as a. CSI-RS, that is linked to the reference RS, such as an AP-CSI-RS. Upon successfully decoding the DCI format providing the TCI-state, the UE selects an DL RX beam and performs DL reception, such as a PDSCH reception, using the DL RX beam associated with the reference CSI-RS (step 805).

Alternatively, the gNB/NW can use the beam report to select a DL RX beam for the UE and indicate to the UE the selected DL RX beam (step 804) using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-CSI-RS, representing the selected DL TX beam (by the gNB/NW). In addition, the TCI-state can also indicate a “target” RS, such as a CSI-RS, that is linked to the reference RS, such as an AP-CSI-RS. Upon successfully decoding the purpose-designed DL channel for beam indication with the TCI state, the UE selects a DL RX beam and performs DL reception, such as a PDSCH reception, using the DL RX beam associated with the reference CSI-RS (step 805).

For this embodiment (A-1), as described above, the UE selects a DL RX beam using an index of a reference RS, such as an AP-CSI-RS, that is provided via the TCI state field, for example in a DCI format. In this case, the CSI-RS resources or, in general, the DL RS resources including CSI-RS, SSB, or a combination of the two, that are configured to the UE as the reference RS resources can be linked to (associated with) a “beam metric” reporting such as CRI/L1-RSRP or L1-SINR.

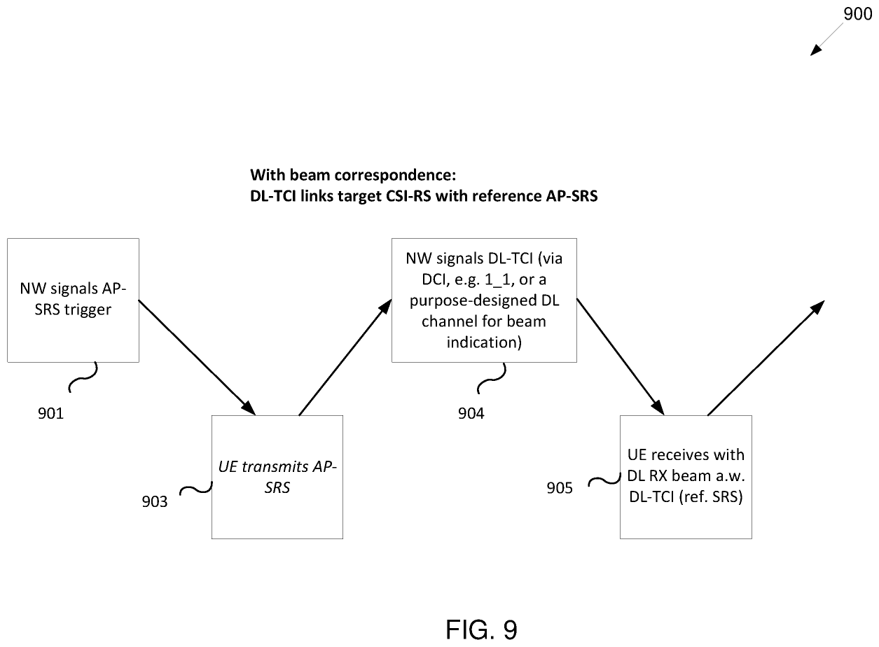

FIG. 9 illustrates an example of DL multi beam operation 900 according to embodiments of the present disclosure. An embodiment of the DL multi beam operation 900 shown in FIG. 9 is for illustration only.

In another example illustrated in FIG. 9 (embodiment A-2), an DL multi-beam operation 900 starts with the gNB/NW signaling to a UE an aperiodic SRS (AP-SRS) trigger or request (step 901). This trigger can be included in a DCI format such as for example a DCI format scheduling a PDSCH reception or a PUSCH transmission. Upon receiving and decoding the DCI format with the AP-SRS trigger (step 902), the UE transmits an SRS (AP-SRS) to the gNB/NW (step 903) so that the NW (or gNB) can measure the UL propagation channel and select a DL RX beam for the UE for DL (at least when there is beam correspondence).

The gNB/NW can then indicate the DL RX beam selection (step 904) through a value of a TCI-state field in a DCI format, such as a DCI format scheduling a PDSCH reception. In this case, the TCI state indicates a reference RS, such as an AP-SRS, representing the selected DL RX beam. In addition, the TCI state can also indicate a “target” RS, such as a CSI-RS, that is linked to the reference RS, such as an AP-SRS. Upon successfully decoding the DCI format providing the TCI state, the UE performs DL receptions, such as a PDSCH reception, using the DL RX beam indicated by the TCI-state (step 905).

Alternatively, the gNB/NW can indicate the DL RX beam selection (step 904) to the UE using a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-SRS, representing the selected DL RX beam. In addition, the TCI-state can also indicate a “target” RS, such as a CSI-RS, that is linked to the reference RS, such as an AP-SRS. Upon successfully decoding a purpose-designed DL channel for beam indication with the TCI-state, the UE performs DL reception, such as a PDSCH reception, with the DL RX beam indicated by the TCI-state (step 905).

For this embodiment (A-2), as described above, the UE selects the DL RX beam based on the UL TX beam associated with the reference RS (AP-SRS) index signaled via the TCI-state field.

Similarly, for UL multi-beam operation, the gNB selects an UL RX beam for every UL TX beam that corresponds to a reference RS. Therefore, when an UL RS, such as an SRS and/or a DMRS, is used as a reference RS, the NW/gNB triggers or configures the UE to transmit the UL RS that is associated with a selection of an UL TX beam. The gNB, upon receiving and measuring the UL RS, selects an UL RX beam. As a result, a TX-RX beam pair is derived. The NW/gNB can perform this operation for all the configured reference RSs, either per reference RS or by “beam sweeping”, and determine all the TX-RX beam pairs associated with all the reference RSs configured to the UE.

Conversely, when a DL RS, such as a CSI-RS and/or an SSB, is used as reference RS (at least when there is DL-UL beam correspondence or reciprocity), the NW/gNB transmits the RS to the UE (for UL and by reciprocity, this RS also corresponds to an UL RX beam). In response, the UE measures the reference RS (and in the process selects an UL TX beam) and reports the beam metric associated with the quality of the reference RS. In this case, the UE determines the TX-RX beam pair for every configured (DL) reference RS. Therefore, although this information is unavailable to the NW/gNB, upon receiving a reference RS (hence an UL RX beam) indication from the NW/gNB, the UE can select the UL TX beam from the information on all the TX-RX beam pairs.

The following two embodiments (B-1 and B-2) are examples of UL multi-beam operations that utilize TCI-based UL beam indication after the network (NW) receives a transmission from the UE. In the first example embodiment (B-1), a NW transmits an aperiodic CSI-RS and a UE receives and measures the CSI-RS. This embodiment can be used, for instance, at least when there is reciprocity between the UL and DL beam-pair-link (BPL). This condition is termed “UL-DL beam correspondence.”

In the second example embodiment (B-2), the NW triggers an aperiodic SRS transmission from a UE and the UE transmits the SRS so that the NW (or a gNB) can measure the UL channel quality for the purpose of assigning an UL TX beam. This embodiment can be used regardless of whether or not there is UL-DL beam correspondence. Although aperiodic RS is considered in these two examples, periodic or semi-persistent RS can also be used.

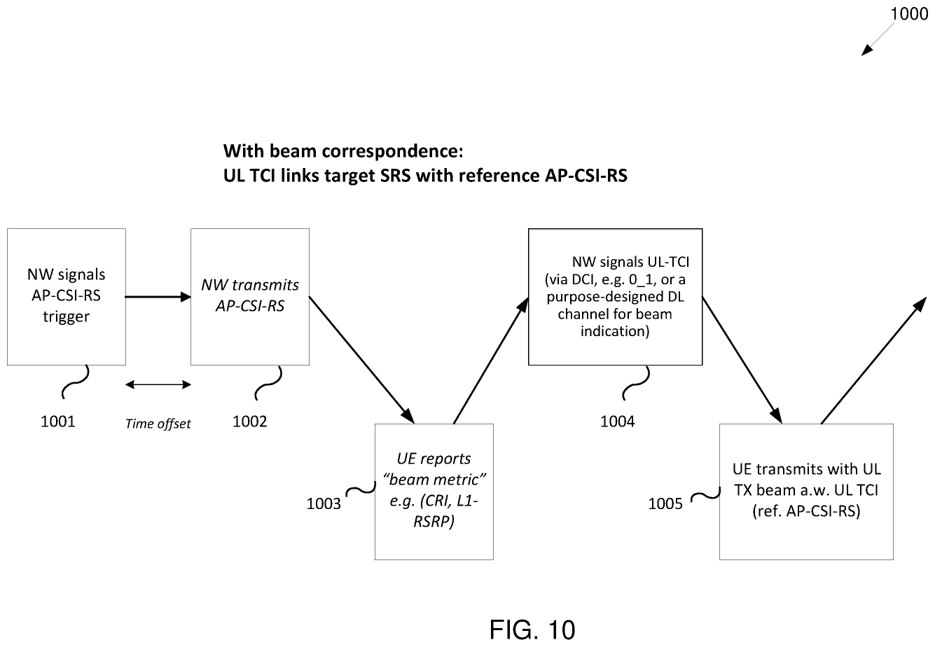

FIG. 10 illustrates an example of UL multi beam operation 1000 according to embodiments of the present disclosure. An embodiment of the UL multi beam operation 1000 shown in FIG. 10 is for illustration only.

In one example illustrated in FIG. 10 (embodiment B-1), an UL multi-beam operation 1000 starts with the gNB/NW signaling to a UE an aperiodic CSI-RS (AP-CSI-RS) trigger or indication (step 1001). This trigger or indication can be included in a DCI format, such as a DCI format scheduling a PDSCH reception to the UE or a PUSCH transmission from the UE and can be either separately or jointly signaled with an aperiodic CSI request/trigger, and indicate transmission of AP-CSI-RS in a same slot (zero time offset) or in a later slot/sub-frame (>0 time offset). Upon receiving the AP-CSI-RS transmitted by the gNB/NW (step 1002), the UE measures the AP-CSI-RS and, in turn, calculates and reports a “beam metric” (indicating quality of a particular TX beam hypothesis) (step 1003). Examples of such beam reporting are CSI-RS resource indicator (CRI) or SSB resource indicator (SSB-RI) together with an associated L1-RSRP/L1-RSRQ/L1-SINR/CQI.

Upon receiving the beam report from the UE, the gNB/NW can use the beam report to select an UL TX beam for the UE and indicate the UL TX beam selection (step 1004) using a TCI-state field in a DCI format, such as a DCI format scheduling a PUSCH transmission from the UE. The TCI-state indicates a reference RS, such as an AP-CSI-RS, representing the selected UL RX beam (by the gNB/NW). In addition, the TCI-state can also indicate a “target” RS, such as a SRS, that is linked to the reference RS, such as an AP-CSI-RS. Upon successfully decoding the DCI format indicating the TCI-state, the UE selects an UL TX beam and performs UL transmission, such as a PUSCH transmission, using the UL TX beam associated with the reference CSI-RS (step 1005).

Alternatively, the gNB/NW can use the beam report to select an UL TX beam for the UE and indicate the UL TX beam selection (step 1004) to the UE using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-CSI-RS, representing the selected UL RX beam (by the gNB/NW). In addition, the TCI-state can also indicate a “target” RS, such as a SRS, that is linked to the reference RS, such as an AP-CSI-RS. Upon successfully decoding a purpose-designed DL channel providing a beam indication by the TCI-state, the UE selects an UL TX beam and performs UL transmission, such as a PUSCH transmission, using the UL TX beam associated with the reference CSI-RS (step 1005).

For this embodiment (B-1), as described above, the UE selects the UL TX beam based on the derived DL RX beam associated with the reference RS index signaled via the value of the TCI-state field. In this case, the CSI-RS resources or, in general, the DL RS resources including CSI-RS, SSB, or a combination of the two, that are configured for the UE as the reference RS resources can be linked to (associated with) “beam metric” reporting such as CRI/L1-RSRP or L1-SINR.

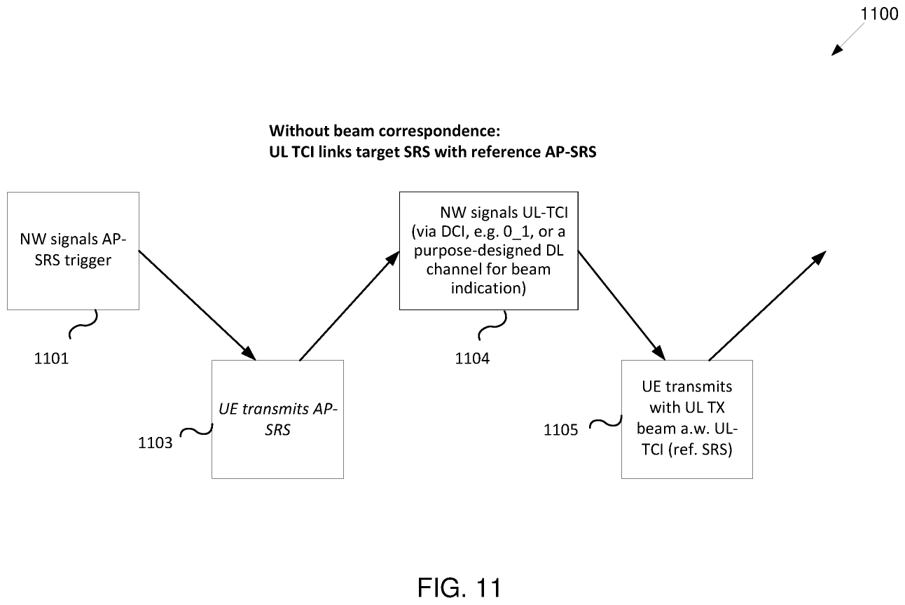

FIG. 11 illustrates an example of UL multi beam operation 1100 according to embodiments of the present disclosure. An embodiment of the UL multi beam operation 1100 shown in FIG. 11 is for illustration only.

In another example illustrated in FIG. 11 (embodiment B-2), an UL multi-beam operation 1100 starts with the gNB/NW signaling to a UE an aperiodic SRS (AP-SRS) trigger or request (step 1101). This trigger can be included in a DCI format, such as a DCI format scheduling a PDSCH reception or a PUSCH transmission. Upon receiving and decoding the DCI format with the AP-SRS trigger (step 1102), the UE transmits AP-SRS to the gNB/NW (step 1103) so that the NW (or gNB) can measure the UL propagation channel and select an UL TX beam for the UE.

The gNB/NW can then indicate the UL TX beam selection (step 1104) using a value of the TCI-state field in the DCI format. In this case, the UL-TCI indicates a reference RS, such as an AP-SRS, representing the selected UL TX beam. In addition, the TCI-state can also indicate a “target” RS, such as a SRS, that is linked to the reference RS, such as an AP-SRS. Upon successfully decoding the DCI format providing a value for the TCI-state, the UE transmits, for example a PUSCH or a PUCCH, using the UL TX beam indicated by the TCI-state (step 1105).

Alternatively, a gNB/NW can indicate the UL TX beam selection (step 1104) to the UE using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the UL-TCI indicates a reference RS, such as an AP-SRS, representing the selected UL TX beam. In addition, the TCI-state can also indicate a “target” RS, such as a SRS, that is linked to the reference RS, such as an AP-SRS. Upon successfully decoding a purpose-designed DL channel for beam indication through a value of the TCI-state field, the UE transmits, such as a PUSCH or a PUCCH, using the UL TX beam indicated by the value of the TCI-state (step 1105).

For this embodiment (B-2), as described above, the UE selects the UL TX beam from the reference RS (in this case SRS) index signaled via the value of the TCI-state field.

In the following components, a TCI state is used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

For high-speed applications, L1/L2-centric inter-cell mobility or inter-cell beam management has been provided in FeMIMO of 3GPP standard specification release 17, to reduce handover latency. A beam measurement report from a UE can include up to K beams associated with at least a non-serving cell, wherein for each beam the UE can report; a measured RS indicator and the beam metric (e.g., L1-RSRP, L3-RSRP, L1-SINR, etc.) associated with the measured RS indicator. A non-serving cell can be a cell with a PCI different from the PCI of the serving cell.

Upon receiving beam measurement reports with beam measurements from non-serving cells and/or the serving cells, the network can decide, based on the beam measurement reports to indicate a beam (e.g., a TCI state or a spatial relation) for non-serving cell for reception and/or transmission of DL and/or UL channels respectively.

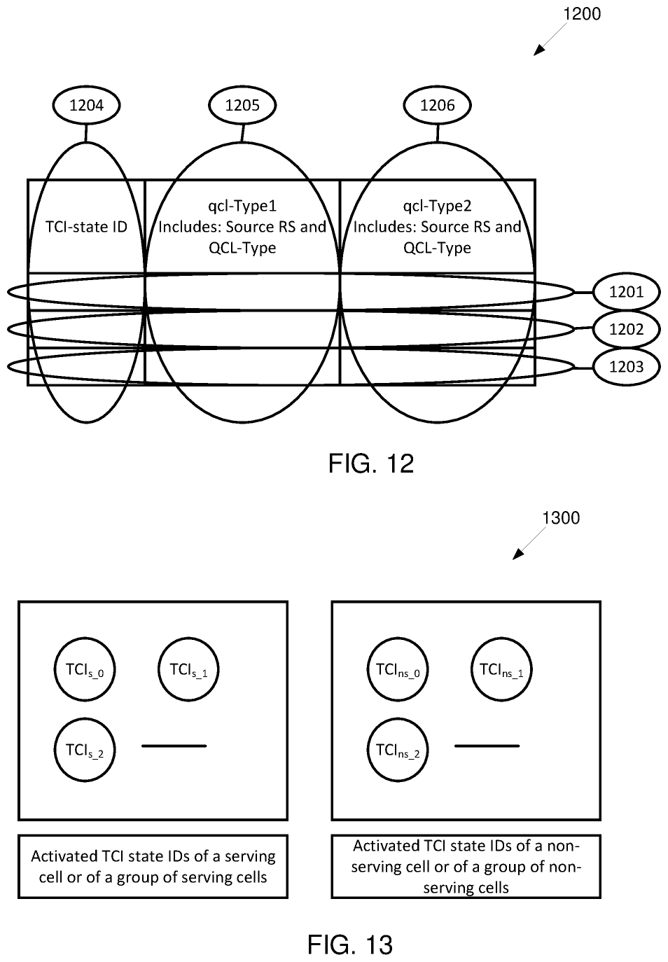

FIG. 12 illustrates an example of TCI state configuration 1200 associated with a TCI state ID according to embodiments of the present disclosure. An embodiment of the TCI state configuration 1200 shown in FIG. 12 is for illustration only.

A TCI-state configuration associates a TCI state ID with one or more source RS as illustrated in FIG. 12. A TCI-state configuration table contains a row for each TCI-state ID (1201, 1202, 1203). Each row contains a TCI-state ID (1204), QCL-Type1 (1205) and optionally QCL-Type2 (1206). Each QCL-Type includes a source reference signal and a QCL-Type, where the QCL-Type can be Type-A, Type-B, Type-C, or Type-D. Each TCI-state can have at most 1 QCL-Type-D. For example, qcl-Type1 can be of QCL-Type A, while qcl-Type2 can be of QCL-Type D.

A source RS in the TCI can be a source RS associated with a serving cell, or a source RS associated with a non-serving cell. The source RS of a serving cell can be at least one of the following: (1) synchronization signal/physical broadcast channel (PBCH) block (SSB) of serving cell; (2) non-zero power (NZP) channel state information—reference signal (CSI-RS), of serving cell, with trs-info enabled. Also known as CSI-RS for tracking or as tracking reference signal (TRS); (3) NZP CSI-RS, of serving cell, without trs-info enabled, and with repetition also known as CSI-RS for beam management; (4) NZP CSI-RS, of serving cell, without trs-info enabled, and without repetition, also known as CSI-RS for CSI; and (5) sounding reference signal (SRS), of serving cell, for beam management.

Similarly, the source RS of a non-serving cell can be at least one of the following: (1) SSB of non-serving cell; (2) NZP CSI-RS, of non-serving cell, with trs-info enabled. Also known as CSI-RS for tracking or as TRS; (3) NZP CSI-RS, of non-serving cell, without trs-info enabled, and with repetition also known as CSI-RS for beam management; (4) NZP CSI-RS, of non-serving cell, without trs-info enabled, and without repetition, also known as CSI-RS for CSI; and (5) SRS, of non-serving cell, for beam management.

When a TCI state contains two QCL info Information Elements with different QCL Types (e.g., Type A and Type D), the source RS of the two QCL info can include the same source RS, or the source RS of the QCL info can be different source RSs as illustrated in TABLE 1.

TABLE 1

| Source Reference Signal for a first QCL | Source Reference Signal for a second QCL |
|---|---|
| Type (e.g., QCL Type A) | Type (e.g., QCL Type D) |
| TRS (CSI-RS for tracking) | SSB |
| TRS (CSI-RS for tracking) | CSI-RS for beam management |
| TRS (CSI-RS for tracking) | CSI-RS for CSI |
| TRS (CSI-RS for tracking) | SRS for beam management |
| CSI-RS for CSI | SSB |
| CSI-RS for CSI | CSI-RS for beam management |
| CSI-RS for CSI | SRS for beam management |
| CSI-RS for CSI | TRS (CSI-RS for tracking) |
| SSB | CSI-RS for beam management |
| SSB | SRS for beam management |
| SSB | TRS (CSI-RS for tracking) |
| SSB | CSI-RS for CSI |
| CSI-RS for beam management | SSB |
| CSI-RS for beam management | SRS for beam management |
| CSI-RS for beam management | TRS (CSI-RS for tracking) |
| CSI-RS for beam management | CSI-RS for CSI |

The TCI states are configured according to FIG. 12 by RRC signaling. A TCI state configuration can include: (1) a TCI state ID and (2) one or more qcl-infos, wherein a qcl-info includes one or more of: (i) a cell index. In one example, the cell index is an index within a group of cells sharing a same physical cell identity (PCI). In another example, a cell index can be index across cells with the same or different PCIs; (ii) a bandwidth part (BWP) identifier; (iii) a PCI; (iv) an RS ID, wherein the reference signal ID can be a SSB index, NZP CSI-RS ID or an SRS ID; and (v) A QCL-Type, for example this can be Type A, Type B, Type C, or Type D.

In one example, the RS ID, is an ID that distinguishes reference signals within a cell. In another example, the RS ID is an ID that distinguishes reference signals within a group of cells sharing the same PCI. In another example, the RS ID is an ID that distinguishes reference signals within cells sharing the same or different PCI.

In a further example, as described by way of example, in U.S. patent application Ser. No. 17/650,062 filed Feb. 4, 2022, which is incorporated by reference herein, TCI states belonging to an entity can be grouped together. For example, an entity can be a cell or a group of cells sharing the same PCI.

The present disclosure provides aspects related to activation and signaling of TCI states.

MAC CE signaling can be used to activate one or more TCI state IDs.

L1 control DCI signaling can be used to indicate to the UE, TCI state ID(s) to apply.

The association between TCI state ID(s) and cell(s) (or cell group(s)) can be configured via RRC signaling. Optionally, the association between TCI state ID(s) and entity (entities) can be configured via RRC signaling.

In one example 1.1, MAC CE signaling activates one or more TCI state IDs.

For MAC CE activation of TCI state IDs: (1) separate MAC CE activation of TCI state IDs associated with serving cell or group of serving cells or non-serving cell(s) or group(s) of non-serving cells, which can include: (i) serving cell or group of serving cells only; (ii) non-serving cell(s) or group(s) of non-serving cells only; and (iii) serving cell or group of serving cells and non-serving cell(s) or group(s) of non-serving cells via separate MAC CEs; and (2) joint MAC CE activation of TCI state IDs associated with serving cell or group of serving cells and non-serving cell(s) or group(s) of non-serving cells.

In one example 1.1.1, the activated TCI state IDs correspond to one or more cells or to one or more groups of cells, wherein a group of cells share a same PCI.

In one example 1.1.1.1, the activated TCI state IDs correspond to: (1) one serving cell or a group of serving cell; and (2) one non-serving cell or a group of non-serving cells.

FIG. 13 illustrates an example of two sets of activated TCI state IDs 1300 according to embodiments of the present disclosure. An embodiment of the two sets of activated TCI state IDs 1300 shown in FIG. 13 is for illustration only.

FIG. 13 illustrates an example of two sets of activated TCI state IDs, wherein a first set belongs to a serving cell or a group of serving cells, and a second set belongs to a non-serving cell or a group of non-serving cells.

In another example 1.1.1.2, the activated TCI state IDs correspond to: (1) one serving cell or a group of serving cells; (2) one or more non-serving cells or one or more groups of non-serving cells; and (3) a UE capability can determine the maximum number of non-serving cells or groups of non-serving cells with activated TCI state IDs.

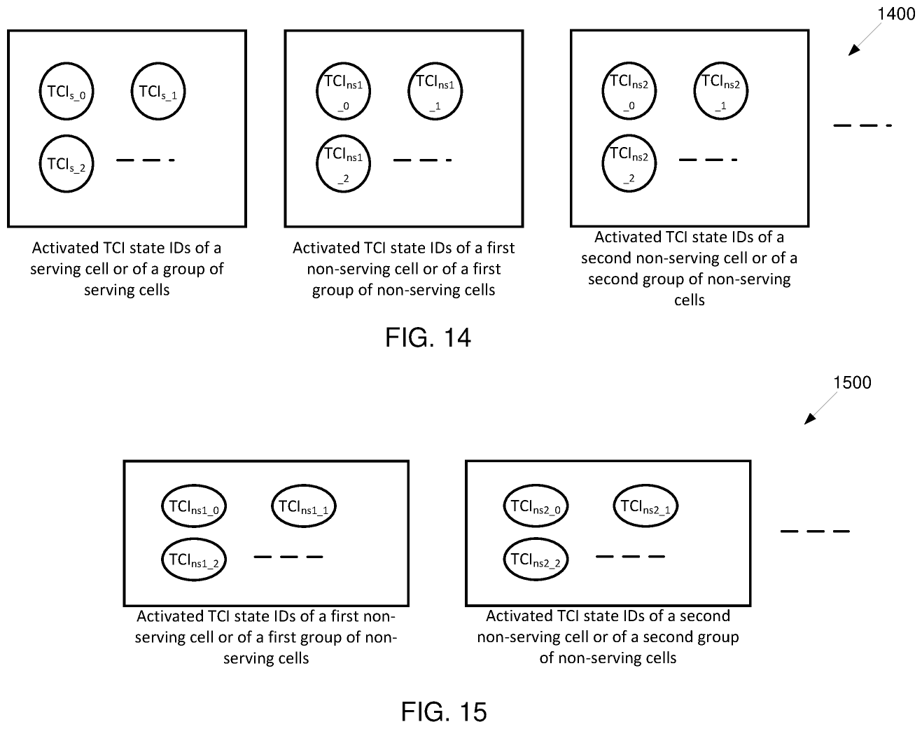

FIG. 14 illustrates an example of three sets of activated TCI state IDs 1400 according to embodiments of the present disclosure. An embodiment of the three sets of activated TCI state IDs 1400 shown in FIG. 14 is for illustration only.

FIG. 14 illustrates an example of three sets of activated TCI state IDs, wherein a first set belongs to a serving cell or a group of serving cells, a second set belongs to a first non-serving cell or a first group of non-serving cells, a third set belongs to a second non-serving cell or a second group of non-serving cells.

In another example 1.1.1.3, the activated TCI state IDs correspond to: (1) one or more non-serving cells or one or more groups of non-serving cells; and (2) a UE capability can determine the maximum number of serving/non-serving cells or groups of serving/non-serving cells with activated TCI state IDs.

FIG. 15 illustrates an example of two sets of activated TCI state IDs 1500 according to embodiments of the present disclosure. An embodiment of the two sets of activated TCI state IDs 1500 shown in FIG. 15 is for illustration only.

FIG. 15 illustrates an example of two sets of activated TCI state IDs, wherein a first set belongs to a first non-serving cell or a first group of non-serving cells, a second set belongs to a second non-serving cell or a second group of non-serving cells.

In another example 1.1.2, the activated TCI state IDs correspond to one cell or to a group of cells, wherein a group of cells share a same PCI.

In one example 1.1.2.1, the activated TCI state IDs correspond to one serving cell or a group of serving cells.

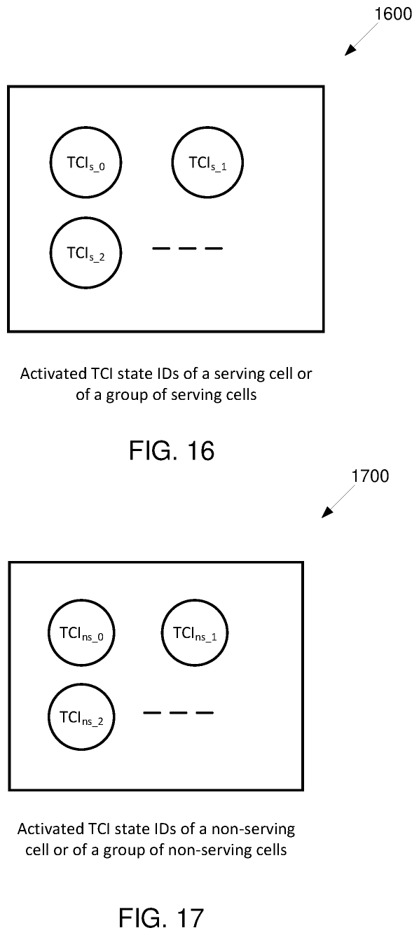

FIG. 16 illustrates an example of a set of activated TCI state IDs 1600 according to embodiments of the present disclosure. An embodiment of the set of activated TCI state IDs 1600 shown in FIG. 16 is for illustration only.

FIG. 16 illustrates an example of a set of activated TCI state IDs, wherein the TCI state IDs belong to a serving cell or a group of serving cells.

In another example 1.1.2.2, the activated TCI state IDs correspond to one non-serving cells or a group of non-serving cells.

FIG. 17 illustrates an example of a set of activated TCI state IDs 1700 according to embodiments of the present disclosure. An embodiment of the set of activated TCI state IDs 1700 shown in FIG. 17 is for illustration only.

FIG. 17 illustrates an example of a sets of activated TCI state IDs, wherein the TCI state IDs belong to a non-serving cell or a group of non-serving cells.

In one example 1.2, there is no MAC CE signaling to activate TCI state IDs. The RRC configured TCI states can be indicated by L1 control DCI signaling.

In one example 1.2.1, a DCI that indicates one or more TCI state IDs, e.g., one or more DL TCI state IDs, and/or one or more UL TCI state IDs and/or one or more joint TCI state IDs indicates TCI state IDs that correspond to one or more cells or to one or more groups of cells, wherein a group of cells share a same PCI. Indicated TCI state IDs can be indicated in the same or separate DCI but are concurrent with each other.

In one example 1.2.1.1, the indicated TCI state IDs correspond to: (1) one serving cell or a group of serving cells; and (2) one non-serving cell or a group of non-serving cells.

In another example 1.2.1.2, the indicated TCI state IDs correspond to: (1) one serving cell or a group of serving cells; (2) one or more non-serving cells or one or more groups of non-serving cells; and (3) a UE capability can determine the maximum number of non-serving cells or non-serving cell groups with concurrently indicated TCI state IDs.

In another example 1.2.1.3, the indicated TCI state IDs correspond to: (1) one or more non-serving cells and/or serving cells or one or more groups of non-serving cells and/or group of serving cells; and (2) a UE capability can determine the maximum number of serving/non-serving cells or groups of serving/non-serving cells with concurrently indicated TCI state IDs.

In another example 1.2.2, a DCI that indicates one or more TCI state IDs, e.g., one or more DL TCI state IDs, and/or one or more UL TCI state IDs and/or one or more joint TCI state IDs indicates TCI state IDs that correspond to one cell or to a group of cells, wherein a group of cells share a same PCI. Indicated TCI state IDs can be indicated in the same or separate DCI but are concurrent with each other.

In one example 1.2.2.1, the indicated TCI state IDs correspond to one serving cell or a group of serving cells.

In another example 1.2.2.2, the indicated TCI state IDs correspond to one non-serving cells or a group of non-serving cells.

In another example 1.3, the activated TCI state IDs belong to a same first cell or a same first group of cells, wherein a group of cells share a same PCI. MAC CE signaling activates one or more TCI state IDs that belong to a different second cell or a different second group of cells, wherein the PCI of the second cell or second group of cells is different from the PCI of the first cell or first group of cells.

In one example 1.3.1, the MAC CE includes an indicated TCI state ID that belongs to the activated TCI state IDs of the new (second) cell or the new (second) group of cells. After a beam application time T₁, the beam corresponding to the indicated TCI state ID is applied, and the TCI state IDs of the new (second) cell or new (second) group of cells become active. The other TCI state IDs, of the old (first) cell or the old (first) group of cells are deactivated.

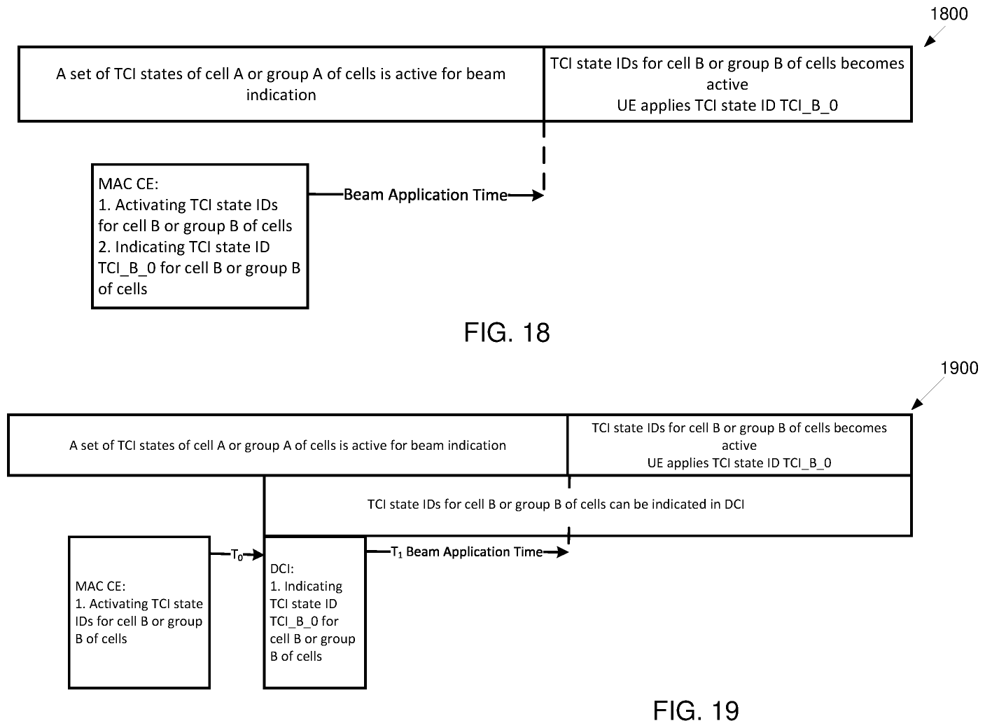

FIG. 18 illustrates an example of a first set of TCI state IDs for a first cell or a first group of cells 1800 according to embodiments of the present disclosure. An embodiment of the first set of TCI state IDs for a first cell or a first group of cells 1800 shown in FIG. 18 is for illustration only.

In FIG. 18, as an example, a first set of TCI state IDs for a first cell or a first group of cells is active. The set is used for beam indication.

A MAC CE: (1) activates a second set of TCI state IDs for a second cell or a second group of cells; and (2) indicates a TCI state ID belonging to the second cell or the second group of cells for a beam.

After a beam application time, the second set of TCI state IDs becomes active and the indicated TCI state ID is applied to a spatial filter for transmission and/or reception.

In another example 1.3.2, a DCI indicates an TCI state ID of the new cell or the new cell group after at least T₀ from the MAC CE activating the TCI states. After a beam application time T₁, the beam corresponding to the indicated TCI state ID is applied, and the TCI state IDs of the new cell or new group of cells become active. The other TCI state IDs, of the old cell or the old group of cells are deactivated.

FIG. 19 illustrates another example of a first set of TCI state IDs for a first cell or a first group of cells 1900 according to embodiments of the present disclosure. An embodiment of the first set of TCI state IDs for a first cell or a first group of cells 1900 shown in FIG. 19 is for illustration only.

In FIG. 19, as an example, a first set of TCI state IDs for a first cell or a first group of cells is active. The set is used for beam indication.

A MAC CE activates a second set of TCI state IDs for a second cell or a second group of cells.

After at least time T₀ the second set of TCI state IDs can be indicated by a DCI. A DCI indicates a TCI state ID belonging to the second cell or the second group of cells for a beam.

After a beam application time T₁, the indicated TCI state ID is applied to a spatial filter for transmission and/or reception.

In another example 1.4, a first activated TCI state IDs belongs to serving cell or a serving group of cells, a second activated TCI state IDs belong to a first non-serving cell or a first group of non-serving cells, wherein a group of cells share a same PCI that is different from the PCI of the serving cell or group of serving cells. MAC CE signaling activates one or more TCI state IDs that belong to a second non-serving cell or a second group of non-serving cells.

For MAC CE activation of TCI state IDs: (1) separate MAC CE activation of TCI state IDs associated with serving cell or group of serving cells from that of non-serving cell(s) or group(s) of non-serving cells, which can include: (i) serving cell or group of serving cells only; (ii) non-serving cell(s) or group(s) of non-serving cells only; and (iii) serving cell or group of serving cells and non-serving cell(s) or group(s) of non-serving cells via separate MAC CEs; and (2) joint MAC CE activation of TCI state IDs associated with serving cell or group of serving cells and non-serving cell(s) or group(s) of non-serving cells.

In one example 1.4.1, the MAC CE includes an indicated TCI state ID that belongs to the activated TCI state IDs of the second non-serving cell or the second group of non-serving cells. After a beam application time T₁, the beam corresponding to the indicated TCI state ID is applied, and the TCI state IDs of the second non-serving cell or the second group of non-serving cells become active. The TCI state IDs, of the first non-serving cell or the first group of non-serving cells are deactivated.

In another example 1.4.2, a DCI indicates an TCI state ID of the second non-serving cell or the second group of non-serving cells after at least T₀ from the MAC CE activating the TCI states. After a beam application time T₁, the beam corresponding to the indicated TCI state ID is applied, and the TCI state IDs of the second non-serving cell or the second group of non-serving cells become active. The other TCI state IDs, of the old (first non-serving) cell or the old (first non-serving) group of cells are deactivated.

A UE has a spatial filter with a source reference signal belonging to a first cell or a first group cells. A first C-RNTI is used to receive and/or transmit channels to/from the UE from/to the first cell or first group of cells. The network indicates a beam (e.g., TCI state ID) with a source reference signal belonging to a second cell or a second group of cells. The network can indicate and/or configure a second C-RNTI to receive and/or transmit channels to/from the UE from/to the second cell or second group of cells.

In one embodiment, a first cell or a first group of cells can be a serving cell or a group of serving cells, a second cell or a second group of cells can be a non-serving cell or a group of non-serving cells.

In another embodiment, a first cell or a first group of cells can be a first non-serving cell or a first group of non-serving cells, a second cell or a second group of cells can be a second non-serving cell or a group of second non-serving cells.

In one embodiment, a first cell or a first group of cells can be a non-serving cell or a group of non-serving cells, a second cell or a second group of cells can be a serving cell or a group of serving cells.

In one example 2.1, the same C-RNTI is used in the first cell or group of cells, and in the second cell or group of cells, wherein a group of cells share a same PCI. There is no additional configuration or signaling of a C-RNTI for the second cell or group of cells.

In another example 2.2, the C-RNTI can be different between the first cell or group of cells, and the second cell or group of cells, wherein a group of cells share a same PCI.

In one example 2.2.1, a second C-RNTI is configured by RRC signaling ahead of a beam change to the second cell or group of cells. When a beam (e.g., a TCI state ID) is indicated to the UE that belongs to the second cell, the second C-RNTI becomes active at the time of application of the beam (e.g., TCI state ID) of the second cell or the second group of cells to a spatial filter. The second cell or second ground of cells is identified by its PCI.

In one example 2.2.1.1, a C-RNTI is configured for all non-serving cells or groups of non-serving cells. When a beam (e.g., a TCI state ID) is indicated for a non-serving cell or a group of non-serving cells the C-RNTI becomes active at the corresponding beam application time. A non-serving cell is a cell having a PCI different from the PCI of the serving cell.

In another example 2.2.1.2, a C-RNTI is configured for each non-serving cells or each group of non-serving cells. When a beam (e.g., a TCI state ID) is indicated for a non-serving cell or a group of non-serving cells the C-RNTI corresponding to the cell or group of cells becomes active at the corresponding beam application time. A non-serving cell is a cell having a PCI different from the PCI of the serving cell.

In another example 2.2.2, a second C-RNTI is indicated by MAC CE signaling.

In one example 2.2.2.1, the second C-RNTI is indicated by and included in the MAC CE message that activates the TCI state IDs of the second cell or the second group of cells. When a beam (e.g., a TCI state ID) is indicated for a second cell or a group of second non-serving cells the C-RNTI becomes active at the corresponding beam application time.

In a variant of example 2.2.2.1, a set of C-RNTI values can be configured by RRC signaling, the MAC CE message indicates one of these configured values.

In another example 2.2.2.2, the second C-RNTI is indicated by a MAC CE message separate from the MAC CE message that activates the TCI state IDs of the second cell or the second group of cells. When a beam (e.g., a TCI state ID) is indicated for a second cell or a group of second non-serving cells the C-RNTI becomes active at the corresponding beam application time.

In a variant of example 2.2.2.2, a set of C-RNTI values can be configured by RRC signaling, the MAC CE message indicates one of these configured values.

In another example 2.2.3, a second C-RNTI is indicated by DCI signaling.

In one example 2.2.3.1, the second C-RNTI is indicated by and included in the DCI that indicates the TCI state ID(s) of the second cell or the second group of cells. The C-RNTI becomes active at the corresponding beam application time.

In a variant of example 2.2.3.1, a set of C-RNTI values can be configured by RRC signaling and/or MAC CE signaling, the DCI signal indicates one of these configured values.

In another example 2.2.3.2, the second C-RNTI is indicated by a DCI separate from the DCI that indicates the TCI state IDs of the second cell or the second group of cells. When a beam (e.g., a TCI state ID) is indicated for a second cell or a group of second cells the C-RNTI becomes active at the corresponding beam application time.

In a variant of example 2.2.3.2, a set of C-RNTI values can be configured by RRC signaling, the DCI message indicates one of these configured values.

In another example 2.2.3.3, there is no C-RNTI in the DCI that activates the TCI state ID(s) of the second cell or the second group of cells. The C-RNTI is determined implicitly based on prior RRC and/or MAC CE configuration, and becomes active at the corresponding beam application time.

In another example 2.2.3.4, the second C-RNTI scrambles the CRC of the channel conveying the beam indication (e.g., TCI state ID). For example, the channel conveying the beam indication can be a DCI Format and the C-RNTI scrambles the CRC of the DCI format. This could require the UE to do hypothesis testing for multiple C-RNTI values to determine the C-RNTI of beam indication.

In one example 2.2.3.4.1, the second C-RNTI is applied starting from the time of receiving the channel conveying the beam indication (e.g., TCI state ID) with a CRC scrambled by the second C-RNTI.

In another example 2.2.3.4.2, the second C-RNTI is applied starting from beam application time of the beam indication (e.g., TCI state ID) conveyed by the channel with a CRC scrambled by the second C-RNTI.

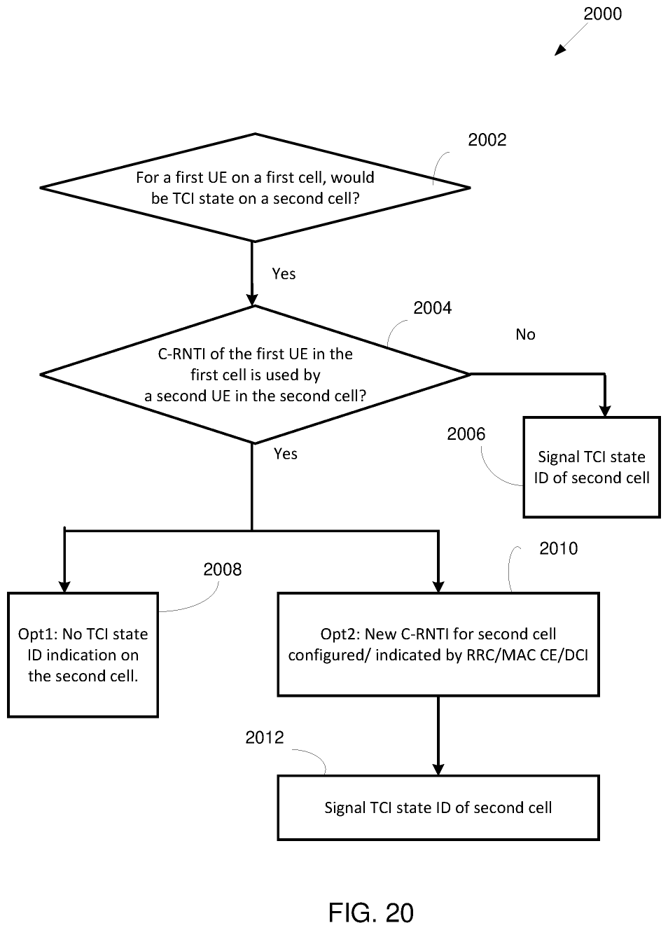

FIG. 20 illustrates a flowchart of method 2000 for C-RNTI checking operation according to embodiments of the present disclosure. The method 2000 as may be performed by a UE (e.g., 111-116 as illustrated in FIG. 1) and a BS (e.g., 101-103 as illustrated in FIG. 1). An embodiment of the method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

In another example 2.3, as illustrated in FIG. 20, the network checks whether or not the C-RNTI used by a first UE in a first cell or a first group of cells is used by a second UE in a second cell or a second group of cells. If the network indicates a beam (e.g., TCI state ID) to the first UE that belongs to second cell or to the second group of cells, and: (1) if the C-RNTI of the second UE in the second cell or group of cells is different from the C-RNTI of the first UE (i.e., there is no UE in the second cell or group of cells using the same C-RNTI as the C-RNTI of the first UE), the first UE can be indicated a beam (e.g., TCI state ID) that belongs to second cell or to the second group of cells, without a change in C-RNTI; and (2) if the C-RNTI of the second UE in the second cell or group of cells is the same as the C-RNTI of the first UE: (i) in one example 2.3.1, the network does not indicate, for the first UE, a beam (e.g., TCI state ID) that belongs to second cell or to the second group of cells; and (ii) in a second example 2.3.2, the network configures or signals a new C-RNTI by RRC signaling and/or MAC CE signaling and/or DCI signaling as described in the previous examples.

As illustrated in FIG. 20, the method 2000 begins at step 2002. In step 2002, a network (e.g., BS) determines, for a first UE on a first cell, a TCI state on a second cell is to be indicated to the UE. In step 2004, the network determines if a C-RNTI of the first UE in the first cell is used by a second UE in the second cell. In step 2006 (if result of step 2004 is “no”), the network signals TCI state ID of second cell. If result of step 2004 is “yes”, either option 1 or option 2. In step 2008 (e.g., option 1), the network identifies a No TCI state ID indication on the second cell. In step 2010 (e.g., option 2), the network identifies a new C-RNTI for a second cell configured/indicated by RRC/MAC CE/DCI. In step 2012, the network signals TCI state ID of second cell.

Upon receiving beam measurement reports with beam measurements from non-serving cells (a.k.a. a cell having a PCI different from the PCI of the serving cell), and/or the serving cells, the network can decide, based on the beam measurement reports to indicate a beam (e.g., a TCI state or a spatial relation or UL source RS) (1) for a cell with a PCI different from that of the serving cell, or (2) for the serving cell.

Beams can be associated with different tracking loops. A tracking loop refers to time and/or frequency tracking. For example, if the entities transmitting and/or receiving the beams to and/or from the UE are associated with different synchronization sources, different tracking loops can be used.

An entity in this disclosure can be: (1) one or more cells, wherein one cell can be associated with one or more physical cell IDs (PCIs); (2) one or more PCIs; (3) one or more TRPs; (4) one or more TRP panels; (5) one or more component carriers; (6) one or more SSBs; (7) one or more UE panels; (8) one or more BWPs; (9) one or more frequency spans (e.g., PRBs or sub-carriers); (10) one or more time intervals (e.g., slots or symbols); and (11) one or more antenna ports.

An entity can be a combination of one or more of the above, for example an entity can be one or more component carriers on one or more TRPs.

As an example, a first entity can be a serving cell, a second entity can be a first non-serving cell, a third entity can be a second non-serving cell, and so on.

In this disclosure beams can be organized into groups. Beams within a group are transmitted and/or received from a same entity. Beams within a group have a same tracking loop.

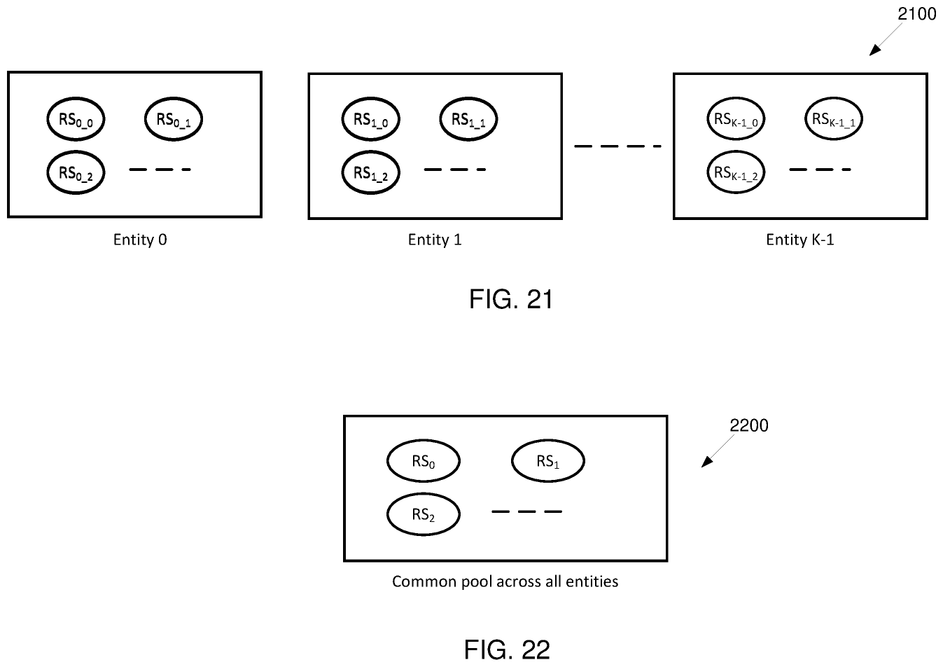

A network can configure a UE with source RS resources for up to K entities (e.g., K cells with each cell having a different PCI) as shown in FIG. 21. In one example, entity 0 can be a serving cell, with a serving cell PCI; entities 1, . . . , K−1 can be cells with a PCI that is different from that of the first (e.g., serving) cell. A first entity can be configured up to M₀ source RS. A second entity can be configured up to M₁ source RS . . . a K^{th}−1 entity can be configured up to M_{K-1} source RS.

In one example, M₀, M₁, . . . M_{K-1} can be different.

In another example, M₀=M₁= . . . =M_{K-1}=M.

In yet another example, a subset of Mᵢ's can have one value, a second subset of Mᵢ's can have a second value and so on.

The maximum number of entities, i.e., beam groups, K can be at least one of: (1) based on a UE capability; (2) specified in system specifications; or (3) configured and/or updated by higher layer signaling, e.g., MAC CE signaling and/or RRC signaling.

FIG. 21 illustrates an example of configuration of entity 2100 according to embodiments of the present disclosure. An embodiment of the configuration of entity 2100 shown in FIG. 21 is for illustration only.

In one example, Entity 0 can correspond to a first cell (e.g., a serving cell with Physical Cell Identity (PCI), PCIₛ). Entity 1 can correspond to a second cell (e.g., a first non-serving cell with PCI PCIₙₛ₁). Entity 3 can correspond to a third cell (e.g., a second non-serving cell with PCI PCIₙₛ₂), and so on . . . .

In another example, Entity 0 can correspond to a first TRP. Entity 1 can correspond to a second TRP. Entity 2 can correspond to a third TRP, and so on . . . .

In another example, Entity 0 can correspond to a first group of cells. Entity 1 can correspond to a second group of cells. Entity 2 can correspond to a third group of cells, and so on.

In one example, the grouping of cells can be based on the time advance (TA) value, which determines the UL transmission time to the cell. Cells with the same uplink transmission time, or with uplink transmission time within a cyclic prefix (CP) duration are in a same group.

In another example, Entity 0 can correspond to a first group of TRPs. Entity 1 can correspond to a second group of TRPs. Entity 2 can correspond to a third group of TRPs, and so on . . . . In one example, the grouping of TRPs can be based on the time advance (TA) value, which determines the UL transmission time to the TRP. TRPs with the same uplink transmission time, or with uplink transmission time within a cyclic prefix (CP) duration are in a same group.

In another example, Entity 0 can correspond to a first TRP or a first group of TRPs on a first cell (e.g., a serving cell with physical cell identity (PCI), PCIₛ), Entity 1 can correspond to a second TRP or a second group of TRPs on a first cell (e.g., a serving cell with Physical Cell Identity (PCI), PCIₛ), Entity 2 can correspond to a third TRP or a third group of TRPs on a second cell (e.g., a first non-serving cell with PCI PCIₙₛ₁), Entity 3 can correspond to a fourth TRP or a fourth group of TRPs on a second cell (e.g., a first non-serving cell with PCI PCIₙₛ₁), and so on . . . .

The source RS can be one of: (1) SSB; (2) NZP-CSI-RS; or (3) SRS.

Alternatively, or additionally, the source RS list can be a common pool across all entities as illustrated in FIG. 22.

FIG. 22 illustrates an example of RS list in a common pool across all entities 2200 according to embodiments of the present disclosure. An embodiment of the RS list in a common pool across all entities 2200 shown in FIG. 22 is for illustration only.

In one example A1.1, there Mᵢ, SSBs per entity i, wherein Mᵢ is maximum number of SSBs (e.g., maxNrofSSBs) for entity i. Wherein, the SSB-index within entity i is given by: SSB-Index::=INTEGER (0 . . . maxNrofSSBs−1).

The SSB-Index identifies an SSB-Block within an SS Burst associated with entity i, e.g., an SS Burst associated with the PCI of entity i.

In one example A1.1.1, M₀, M₁, . . . M_{K-1} can be different, e.g., the maxNrofSSBs can be different for each entity i.

In another example A1.1.2, M₀=M₁= . . . =M_{K-1}=M, e.g., the maxNrofSSBs is the same across all entities.

In yet another example A1.1.3, a subset of Mᵢ's can have one value, a second subset of Mᵢ's can have a second value and so on. For example, M₀ corresponding to maxNrofSSBs of serving cell(s) can have one value, and M₁, . . . , M_{K-1} corresponding to maxNrofSSBs of cells with a PCI different from that of the serving cell can have another value.

In one example A1.1.4, M₀, M₁, . . . M_{K-1} can be configured and/or updated by RRC signaling and/or MAC CE signaling and/or L1 control signaling.

In another example A1.1.5, M (cf. example A1.1.2) can be configured and/or updated by RRC signaling and/or MAC CE signaling and/or L1 control signaling.

In another example A1.1.6, M (cf. example A1.1.2) can be specified in the system specifications.

In one example A1.1.6.1, M is the maximum across all frequency ranges, or defined across all frequency ranges, e.g., M=64.

In another example A1.1.6.2, M is defined per frequency range, e.g., for FR1 M=8, and for FR2 M=64.

In one example A1.2, there Mᵢ, NZP CSI-RS per entity i, wherein Mᵢ is maximum number of NZP CSI-RS (e.g., maxNrofNZP-CSI-RSinEntity) for entity i. Wherein, the NZP-CSI-RS-ResourceId within entity i is given by: NZP-CSI-RS-ResourceId::=INTEGER (0 . . . maxNrofNZP-CSI-RSinEntity−1).

The NZP-CSI-RS-ResourceId identifies a NZP CSI-RS associated with entity i, e.g., a NZP CSI-RS configured for entity i.

In one example A1.2.1, M₀, M₁, . . . M_{K-1} can be different, e.g., the maxNrofNZP-CSI-RSinEntity can be different for each entity i.

In another example A1.2.2, M₀=M₁= . . . =M_{K-1}=M, e.g., the maxNrofNZP-CSI-RSinEntity is the same across all entities.

In yet another example A1.2.3, a subset of Mᵢ's can have one value, a second subset of Mᵢ's can have a second value and so on. For example, M₀ corresponding to maxNrofNZP-CSI-RSinEntity of serving cell(s) can have one value, and M₁, . . . , M_{K-1} corresponding to maxNrofNZP-CSI-RSinEntity of cells with a PCI different from that of the serving cell can have another value.

In one example A1.2.4, M₀, M₁, . . . M_{K-1} can be configured and/or updated by RRC signaling and/or MAC CE signaling and/or L1 control signaling.

In another example A1.2.5, M (cf. example A1.2.2) can be configured and/or updated by RRC signaling and/or MAC CE signaling and/or L1 control signaling.

In another example A1.2.6, M (cf. example A1.2.2) can be specified in the system specifications.

In one example A1.2.6.1, M is the maximum across all frequency ranges, or defined across all frequency ranges.

In another example A1.2.6.2, M is defined per frequency range.

In one example A1.3, there is a pool of M NZP CSI-RS across all entities, wherein M is the maximum number of NZP CSI-RS (e.g., maxNrofNZP-CSI-RS) across all entities.

In one example A1.4, there Mᵢ, SRS per entity i, wherein Mᵢ is maximum number of SRS (e.g., maxNrofSRS-ResourcesinEntity) for entity i. Wherein, the SRS-ResourceId within entity i is given by: SRS-ResourceId::=INTEGER (0 . . . maxNrofSRS-ResourcesinEntity−1).

The SRS-ResourceId identifies an SRS associated with entity i, e.g., an SRS configured for entity i.

In one example A1.4.1, M₀, M₁, . . . M_{K-1} can be different, e.g., the maxNrofSRS-ResourcesinEntity can be different for each entity i.

In another example A1.4.2, M₀=M₁= . . . =M_{K-1}=M, e.g., the maxNrofSRS-ResourcesinEntity is the same across all entities.

In yet another example A1.4.3, a subset of Mᵢ's can have one value, a second subset of Mᵢ's can have a second value and so on. For example, M₀ corresponding to maxNrofSRS-ResourcesinEntity of serving cell(s) can have one value, and M₁, . . . , M_{K-1} corresponding to maxNrofSRS-ResourcesinEntity of cells with a PCI different from that of the serving cell can have another value.

In one example A1.4.4, M₀, M₁, . . . M_{K-1} can be configured and/or updated by RRC signaling and/or MAC CE signaling and/or L1 control signaling.

In another example A1.4.5, M (cf. example A1.4.2) can be configured and/or updated by RRC signaling and/or MAC CE signaling and/or L1 control signaling.

In another example A1.4.6, M (cf. example A1.4.2) can be specified in the system specifications.

In one example A1.4.6.1, M is the maximum across all frequency ranges, or defined across all frequency ranges.

In another example A1.4.6.2, M is defined per frequency range.

In one example A1.5, there is a pool of M SRS resources across all entities, wherein M is the maximum number of SRS (e.g., maxNrofSRS-Resources) across all entities.

In this component, the source reference signal of a TCI state can be identified by its resource ID within an entity and an index of an entity.

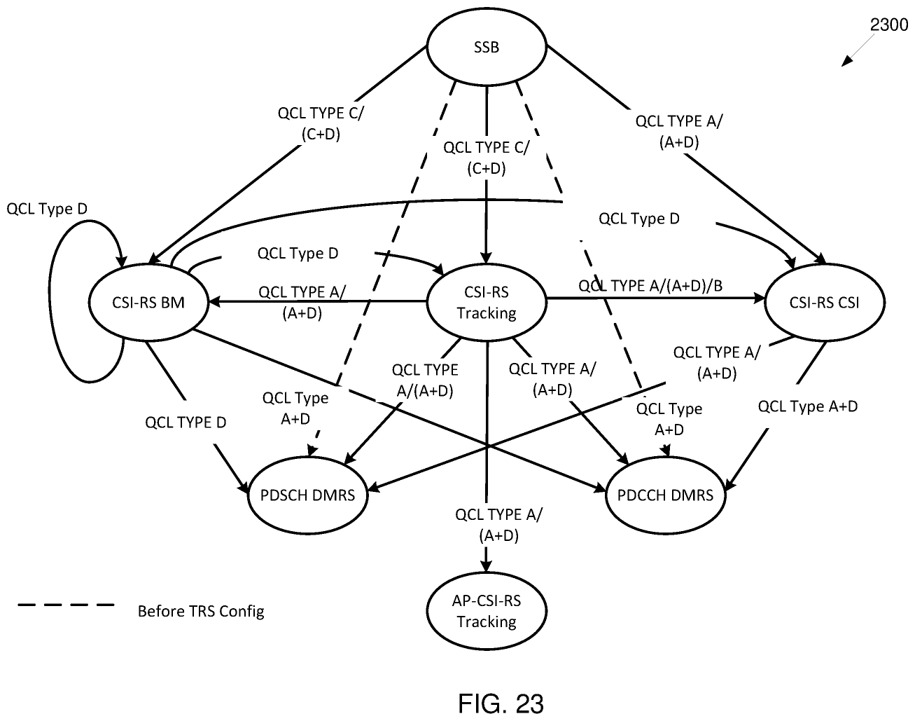

FIG. 23 illustrates an example of QCL/Source RS relations 2300 according to embodiments of the present disclosure. An embodiment of the QCL/Source RS relations 2300 shown in FIG. 23 is for illustration only.

FIG. 23 illustrates an example of possible QCL/Source RS relations. The SSB can be the source RS, of QCL Type A, or QCL Type A+D, or QCL C, or QCL Type C+D for: (1) NZP CSI-RS for BM, e.g., NZP CSI-RS configured with higher layer parameter “repetition”; (2) NZP CSI-RS for Tracking (TRS), e.g., NZP CSI configured with higher layer parameter “trs-info”; and (3) NZP CSI-RS for CSI, e.g., NZP CSI configured without higher layer parameter “trs-info” and without higher layer parameter “repetition.”

Before TRS configuration the SSB can be a source RS, or QCL Type A+D for PDSCH DMRS and PDCCH DMRS.

In addition (not shown in FIG. 23), the SSB can be the source RS for SRS.

The CSI-RS for BM can be a source RS of Type D for: (1) CSI-RS for tracking; (2) CSI-RS for CSI; (3) PDSCH DMRS; and (4) PDCCH DMRS.

The CSI-RS for Tracking can be a source RS of Type A or Type A+D or Type B for: (1) CSI-RS for BM; (2) CSI-RS for CSI; (3) PDSCH DMRS; (4) PDCCH DMRS; and (5) Aperiodic CSI-RS for tracking.

The CSI-RS for CSI can be a source RS of Type A+D or Type D for: (1) PDSCH DMRS and (2) PDCCH DMRS.

The QCL relation or the source RSspatial relation can be established through a TCI state. A TCI-state configuration associates a TCI state ID with one or more source RS as illustrated in FIG. 12. A TCI-state configuration table contains a row for each TCI-state ID (1201, 1202, 1203). Each row contains a TCI-state ID (1204), QCL-Type1 (1205), and optionally QCL-Type2 (1206). Each QCL-Type includes a source reference signal and a QCL-Type, where the QCL-Type can be Type-A, Type-B, Type-C or Type-D. Each TCI-state can have at most 1 QCL-Type-D. For example, qcl-Type1 can be of QCL-Type A, while qcl-Type2 can be of QCL-Type D. A reference signal can be a reference signal of an entity as illustrated in FIG. 21.

In one example, the source RS of qcl-Type1 and the source RS of qcl-Type2, if applicable, can be one of: (1) source RSs from the same entity or from different entities or (2) the same source RS, wherein the source RS can be at least one of the following: (i) SSB; (ii) NZP CSI-RS; or (3) SRS, for beam management. In NZP CSI-RS, the NZP CSI-RS is: (1) configured with higher layer parameter trs-info. Also known as CSI-RS for tracking or as tracking reference signal (TRS); (2) configured with higher layer parameter “repetition.” Also known as CSI-RS for beam management; and/or (3) without higher layer parameter “trs-info,” and without higher layer parameter “repetition,” also known as CSI-RS for CSI.

The source RS can be configured as separate set, list, group or pool for each entity as illustrated in FIG. 21, and example A1.1, example A1.2 and example A1.4.

Alternatively, the RS can be configured as a common set, list, group or pool across all entities as illustrated in FIG. 22 and example A1.3 and example A1.5.

In one example A2.1, an SSBsource RS within a TCI state includes the index of the entity (e.g., PCI) associated with the SSBsource RS. As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In this example, the SSB includes two fields: (1) the SSB-Index within the entity; and (2) the index of the entity, for example the PCI of the entity.

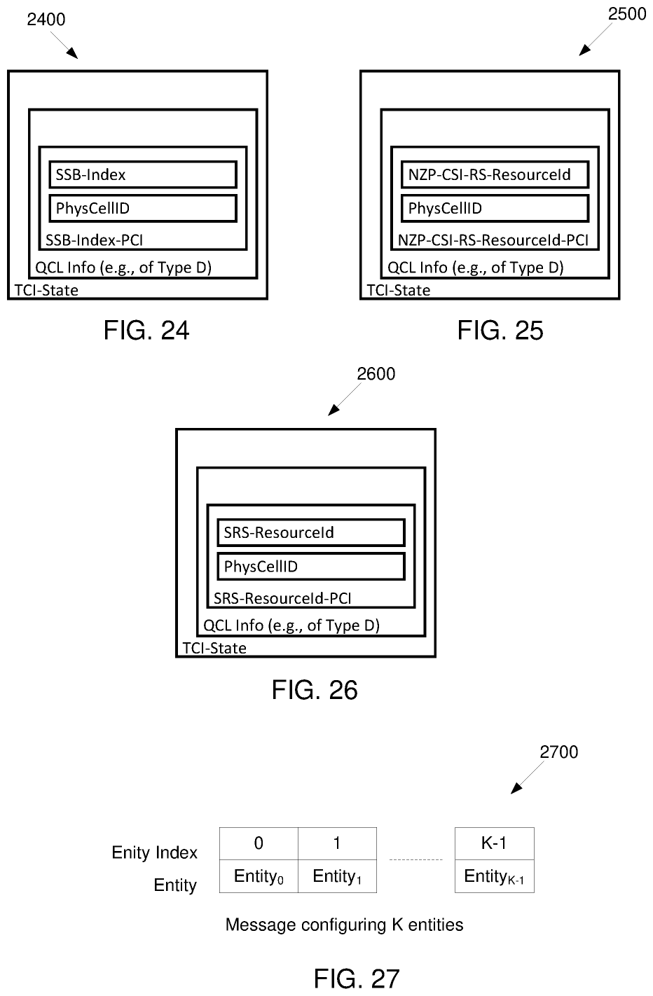

FIG. 24 illustrates an example of SSB-Index-PCI 2400 according to embodiments of the present disclosure. An embodiment of the SSB-Index-PCI 2400 shown in FIG. 24 is for illustration only.

An example for illustration is shown in FIG. 24 for SSB-Index-PCI which is the index of the SSB within the entity and the index of the entity (e.g., PCI of cell associated with the SSB):

| | |
|---|---|
| SSB-Index-PCI ::= | SEQUENCE { |
| ssb | SSB-Index |
| pci | PhysCellId |
| }. | |

In one example A2.2, a NZP CSI-RS source RS within a TCI state includes the index of the entity (e.g., PCI) associated with the NZP-CSI-RS source RS (cf. example A1.2). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In this example, the NZP-CSI-RS includes two fields: (1) the NZP-CSI-RS-ResourceId within the entity; and (2) the index of the entity, for example the PCI of the entity.

FIG. 25 illustrates an example of NZP-CSI-RS-ResourceId-PCI 2500 according to embodiments of the present disclosure. An embodiment of the NZP-CSI-RS-ResourceId-PCI 2500 shown in FIG. 25 is for illustration only.

An example for illustration is shown in FIG. 25 for NZP-CSI-RS-ResourceId-PCI which is the index of the NZP-CSI-RS within the entity and the index of the entity (e.g., PCI of cell associated with the NZP-CSI-RS):

| | |
|---|---|
| NZP-CSI-RS-ResourceId-PCI ::= | SEQUENCE { |
| NZP-CSI-RS | NZP-CSI-RS-ResourceId |
| pci | PhysCellId |
| }. | |

In one example A2.3, an SRS source RS within a TCI state includes the index of the entity (e.g., PCI) associated with the SRS source RS (cf. example A1.4). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In this example, the SRS includes two fields: (1) the SRS-ResourceId within the entity; and (2) the index of the entity, for example the PCI of the entity.

An example for illustration is shown in FIG. 26 for SRS-ResourceId-PCI which is the index of the SRS within the entity and the index of the entity (e.g., PCI of cell associated with the SRS):

| | |
|---|---|
| SRS-ResourceId-PCI ::= | SEQUENCE { |
| SRS | SRS-ResourceId |
| pci | PhysCellId |
| }. | |

FIG. 26 illustrates an example of SRS-Resource ID 2600 according to embodiments of the present disclosure. An embodiment of the SRS-Resource ID 2600 shown in FIG. 26 is for illustration only.

In one example A2.4, the maximum number of configured entities K (see FIG. 21) can depend on a UE capability and/or can be specified in the system specifications. An entity can be a cell with a PCI. The number of entities K can be configured and/or updated by RRC signaling and/or MAC CE signaling. The identities of the configured entities can be configured by RRC signaling and/or MAC CE signaling. For example, identity of an entity can be the Physical Cell Identity (PCI) of the entity. A list of up to K PCIs is configured, e.g., {PCI₀, PCI₁, . . . , PCI_{K-1}}, the entity index can be the order (position) of the entity in the list, or it can be separately configured as shown in FIG. 27. For an entity with index i within the list and physical cell identity PCIᵢ, the number of source reference signals of a type or across all types is Mᵢ. A type of a source reference signal can be SSB, NZP CSI-RS or SRS.

FIG. 27 illustrates an example of entity configuration 2700 according to embodiments of the present disclosure. An embodiment of the entity configuration 2700 shown in FIG. 27 is for illustration only.

In one example 2A.5, an SSBsource RS within a TCI state includes the index of the entity within the configured list, as described in example A2.4, associated with the SSBsource RS. As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In a variant example, the entity index/ID could be an index/ID of another RRC parameter indicating non-serving cell (e.g., cell with PCI different from the PCI of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the SSB includes two fields: (1) the SSB-Index within the entity; and (2) the index of the entity within the list of configured entities.

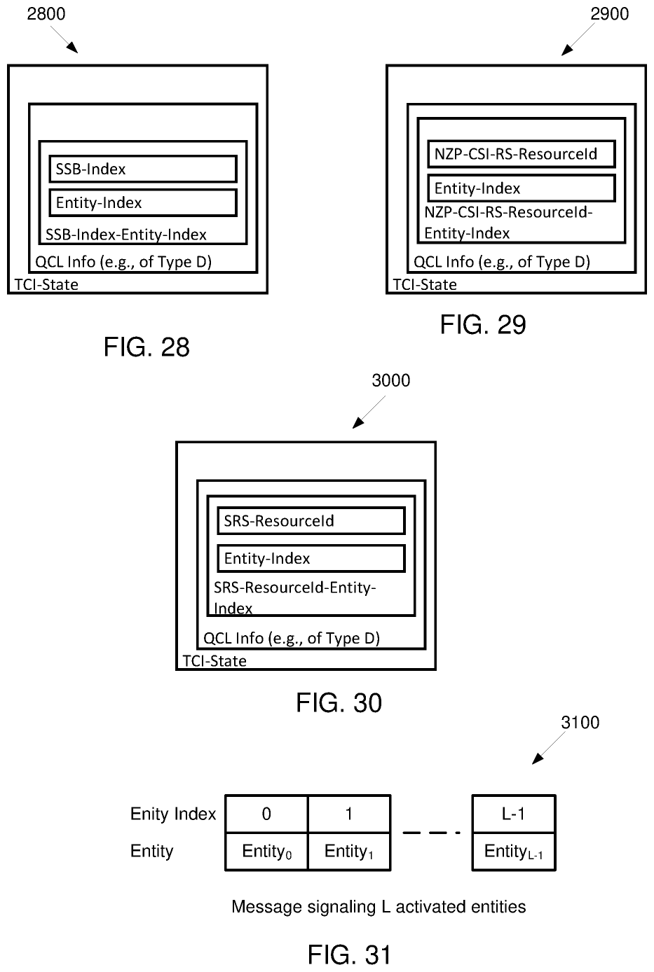

An example for illustration is shown in FIG. 28 for SSB-Index-Entity-Index which is the index of the SSB within the entity and the index of the entity within the list of configured entities:

| SSB-Index-Entity-Index ::= SEQUENCE { | |
|---|---|
| ssb | SSB-Index |
| entity | Entity-Index |
| }. | |

FIG. 28 illustrates an example of SSB-Index-Entity-Index 2800 according to embodiments of the present disclosure. An embodiment of the SSB-Index-Entity-Index 2800 shown in FIG. 28 is for illustration only.

FIG. 28 only shows the IEs of interested, other IEs are not shown.

In one example A2.6, a NZP CSI-RS source RS within a TCI state includes the index of the entity within the configured list, as described in example A2.4, associated with the NZP-CSI-RS source RS (cf. example A1.2). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; and (3) SRS.

In a variant example, the entity index/ID could be an index/ID of another RRC parameter indicating non-serving cell (e.g., cell with PCI different from that of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the NZP-CSI-RS includes two fields: (1) the NZP-CSI-RS-ResourceId within the entity; and (2) the index of the entity within the list of configured entities.

An example for illustration is shown in FIG. 29 for NZP-CSI-RS-ResourceId-Entity-Index which is the index of the NZP-CSI-RS within the entity and the index of the entity within the list of configured entities:

| NZP-CSI-RS-ResourceId-Entity-Index ::= SEQUENCE { | |
|---|---|
| NZP-CSI-RS | NZP-CSI-RS-ResourceId |
| entity | Entity-Index |
| }. | |

FIG. 29 illustrates an example of NZP-CSI-RS-ResourceId-Entity-Index 2900 according to embodiments of the present disclosure. An embodiment of the NZP-CSI-RS-ResourceId-Entity-Index 2900 shown in FIG. 29 is for illustration only.

FIG. 29 only shows the IEs of interested, other IEs are not shown.

In one example A2.7, an SRS source RS within a TCI state includes the index of the entity within the configured list, as described in example A2.4, associated with the SRS source RS (cf. example A1.4). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In a variant example, the entity index/ID could be an index/ID of another RRC parameter indicating non-serving cell (e.g., cell with PCI different from that of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the SRS includes two fields: (1) the SRS-ResourceId within the entity; and (2) the index of the entity within the list of configured entities.

An example for illustration is shown in FIG. 30 for SRS-ResourceId-Entity-Index which is the index of the SRS within the entity and the index of the entity within the list of configured entities:

| SRS-ResourceId-Entity-Index ::= SEQUENCE { | |
|---|---|
| SRS | SRS-ResourceId |
| entity | Entity-Index |
| } | |

FIG. 30 illustrates an example of SRS-ResourcedId-Entity-Index 3000 according to embodiments of the present disclosure. An embodiment of the SRS-ResourcedId-Entity-Index 3000 shown in FIG. 30 is for illustration only.

FIG. 30 only shows the IEs of interested, other IEs are not shown.

In examples A2.1, A2.2, A2.3, the size of PCI in the RS resource is 10 bits, as there are 1008 PCIs.

In example A2.5, A2.6, A2.7, the size of the entity index is ┌Log₂ K┐. Where, K is the number of configured entities. If K=4, the size of entity index is 2 bits.

In one sub-example of example A2.5, A2.6, and A2.7, K=2. Reference signals for two entities are configured, for example one entity can be the serving cell, a second entity can be a cell with a PCI different from the PCI of the serving cell. In this case, the entity index in examples A2.5, A2.6, and A2.7 and corresponding FIGS. 28, 29, and 30 is a one-bit flag. For example, 0 corresponds to a reference signal from the serving cell and 1 corresponds to a reference signal from the cell with a PCI different from that of the serving cell, or vice versa.

In one example A2.8, the maximum number of entities configured is K. Out of the K entities, L entities can have activated TCI states, this is denoted as the activated list. Wherein, L can depend on a UE capability and/or can be specified in the system specifications. An entity can be a cell with a PCI. The number of entities L can be configured and/or updated by RRC signaling and/or MAC CE signaling, or implicitly determined based on the entities with activated TCI states. The identities of the entities with or that can have activated TCI states can be configured by RRC signaling and/or MAC CE signaling. For example, identity of an entity can be the Physical Cell Identity (PCI) of the entity.

A list of up to L PCIs is configured in the activated list, e.g., {PCI₀, PCI₁, . . . , PCI_{L-1}}, the entity index can be the order (position) of the entity in the list, or it can be separately configured for the activated entities as shown in FIG. 31. For an entity with index i within the list and physical cell identity PCIᵢ, the number of source reference signals of a type or across all types is Mᵢ. A type of a source reference signal can be SSB, NZP CSI-RS or SRS.

FIG. 31 illustrates an example of entity configuration 3100 according to embodiments of the present disclosure. An embodiment of the entity configuration 3100 shown in FIG. 31 is for illustration only.

In one example A2.9, an SSBsource RS within a TCI state includes the index of the entity within the activated list, as described in example A2.8, associated with the SSBsource RS. As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In a variant example, the entity index/ID could be an index/ID of another RRC parameter indicating non-serving cell (e.g., cell with PCI different from that of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the SSB includes two fields: (1) the SSB-Index within the entity; and (2) the index of the entity within the list of activated entities.

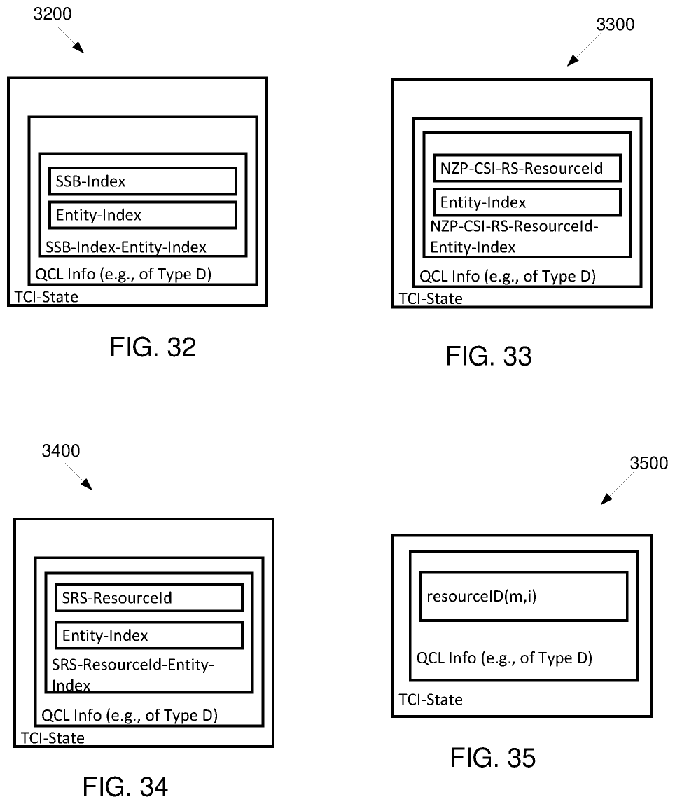

An example for illustration is shown in FIG. 32 for SSB-Index-Entity-Index which is the index of the SSB within the entity and the index of the entity within the list of activated entities:

| SSB-Index-Entity-Index ::= SEQUENCE { | |
|---|---|
| ssb | SSB-Index |
| entity | Entity-Index |
| }. | |

FIG. 32 illustrates an example of SSB-Index-Entity-Index 3200 according to embodiments of the present disclosure. An embodiment of the SSB-Index-Entity-Index 3200 shown in FIG. 32 is for illustration only.

FIG. 32 only shows the IEs of interested, other IEs are not shown.

In one example A2.10, a NZP CSI-RS source RS within a TCI state includes the index of the entity within the activated list, as described in example A2.8, associated with the NZP-CSI-RS source RS (cf. example A1.2). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In a variant example, the entity index/ID could be an index/ID of another RRC parameter indicating non-serving cell (e.g., cell with PCI different from that of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the NZP-CSI-RS includes two fields: (1) the NZP-CSI-RS-ResourceId within the entity; and (2) the index of the entity within the list of activated entities.

An example for illustration is shown in FIG. 33 for NZP-CSI-RS-ResourceId-Entity-Index which is the index of the NZP-CSI-RS within the entity and the index of the entity within the list of activated entities:

| NZP-CSI-RS-ResourceId-Entity-Index ::= SEQUENCE { | |
|---|---|
| NZP-CSI-RS | NZP-CSI-RS-ResourceId |
| entity | Entity-Index |
| }. | |

FIG. 33 illustrates an example of NZP-CSI-RS-ResourceId-Entity-Index 3300 according to embodiments of the present disclosure. An embodiment of the NZP-CSI-RS-ResourceId-Entity-Index 3300 shown in FIG. 33 is for illustration only.

FIG. 33 only shows the IEs of interested, other IEs are not shown.

In one example A2.11, an SRS source RS within a TCI state includes the index of the entity within the activated list, as described in example A2.8, associated with the SRS source RS (cf. example A1.4). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In a variant example, the entity index/ID could be an index/ID of another RRC parameter indicating non-serving cell (e.g., cell with PCI different from the PCI of the serving cell) information such as non-serving cell SSB time-domain position, SSB frequency-domain position, PCI and etc. e.g.:

InterCellSSBInfo:={
InterCellSSBInfoId
SSB time domain
SSB frequency domain
SSB transmit power
PCI
. . .
}.

In this example, the SRS includes two fields: (1) the SRS-ResourceId within the entity; and (2) the index of the entity within the list of activated entities.

An example for illustration is shown in FIG. 34 for SRS-ResourceId-Entity-Index which is the index of the SRS within the entity and the index of the entity within the list of activated entities:

| SRS-ResourceId-Entity-Index ::= SEQUENCE { | |
|---|---|
| SRS | SRS-ResourceId |
| entity | Entity-Index |
| }. | |

FIG. 34 illustrates an example of SRS-ResourcedId-Entity-Index 3400 according to embodiments of the present disclosure. An embodiment of the SRS-ResourcedId-Entity-Index 3400 shown in FIG. 34 is for illustration only.

FIG. 34 only shows the IEs of interested, other IEs are not shown.

In example A2.9, A2.10, A2.11, the size of the entity index is ┌Log₂ L┐. Where, L is the number of activated entities. If L=4, the size of entity index is 2 bits.

In one sub-example of example A2.9, A2.10, and A2.11, L=2. TCI state for two entities are activated, for example one entity can be the serving cell, a second entity can be a cell with a PCI different from that of the serving cell. In this case, the entity index in examples A2.9, A2.10, and A2.11 and corresponding FIGS. 32, 33, and 34 is a one-bit flag. For example, 0 corresponds to a reference signal from the serving cell and 1 corresponds to a reference signal from the cell with a PCI different from the PCI of the serving cell, or vice versa.

In one example A2.12, the maximum number of configured entities K (see FIG. 21) can depend on a UE capability and/or can be specified in the system specifications. An entity can be a cell with a PCI. The number of entities K can be configured and/or updated by RRC signaling and/or MAC CE signaling. The identities of the configured entities can be configured by RRC signaling and/or MAC CE signaling.

For example, identity of an entity can be the Physical Cell Identity (PCI) of the entity. A list of up to K PCIs is configured, e.g., {PCI₀, PCI₁, PCI_{K-1}}, the entity index can be the order (position) of the entity in the list, or it can be separately configured as shown in FIG. 27. For an entity with index i within the list and physical cell identity PCIᵢ, the number of source reference signals of a type or across all types is Mᵢ. A type of a source reference signal can be SSB, NZP CSI-RS or SRS. The index of the source reference signal is determined by counting the index across all configured entities first in ascending order of the index of the source reference signal within the entity, and then in ascending order across entities.

In one example A2.12.1, M₀, M₁, . . . , Mᵢ, M_{K-1} can be different for each entity i. m is the resourceID of a reference signal within entity i. The resourceID of reference signal m in entity i can be given by: resourceId(m, i)=Σⱼ₌₀ⁱ⁻¹Mⱼ+m.

In another example 2.12.2, M₀=M₁= . . . =M_{K-1}=M, i.e., the number of reference signals in each entity is the same. m is the resourceID of a reference signal within entity i. The resourceID of reference signal m in entity i can be given by: resourceId(m, =M·i+m.

In another example 2.12.3, M₀, M₁, . . . , Mᵢ, M_{K-1} can be different for each entity i. m is the resourceID of a reference signal within entity i. Mₘₐₓ=max(M₀, M₁, . . . , M_{K-1}). The resourceID of reference signal m in entity i can be given by: resourceId(m, i)=Mₘₐₓ·i+m.

FIG. 35 illustrates an example of QCL-Info 3500 according to embodiments of the present disclosure. An embodiment of the QCL-Info 3500 shown in FIG. 35 is for illustration only.

FIG. 35, illustrates an example of inclusion of the resourceID of example A2.12.1, A2.12.2, or A2.12.3 in the TCI state. FIG. 35 only shows the IEs of interested, other IEs are not shown.

resourceId(m, i) of examples A2.12.1, A2.12.2, and A2.12.3 and FIG. 35, can be for one of the following reference signals: (1) SSB; (2) NZP CSI-RS; or (3) SRS.

In one example A2.13, the maximum number of configured entities K. Out of the K entities, L entities can have activated TCI states, this is denoted as the activated list. Wherein, L can depend on a UE capability and/or can be specified in the system specifications. An entity can be a cell with a PCI. The number of entities L can be configured and/or updated by RRC signaling and/or MAC CE signaling, or implicitly determined based on the entities with activated TCI states. The identities of the entities with or that can have activated TCI states can be configured by RRC signaling and/or MAC CE signaling.

For example, identity of an entity can be the PCI of the entity. A list of up to L PCIs is configured in the activated list, e.g., {PCI₀, PCI₁, . . . , PCI_{L-1}}, the entity index can be the order (position) of the entity in the list, or it can be separately configured for the activated entities as shown in FIG. 31. For an entity with index i within the list and physical cell identity PCIᵢ, the number of source reference signals of a type or across all types is M₁. A type of a source reference signal can be SSB, NZP CSI-RS or SRS. The index of the source reference signal is determined by counting the index across all activated entities first in ascending order of the index of the source reference signal within the entity, and then in ascending order across entities.

In one example A2.13.1, M₀, M₁, . . . , Mᵢ, M_{K-1} can be different for each entity i. m is the resourceID of a reference signal within entity i. The resourceID of reference signal m in entity i can be given by: resourceId(m, i)=Σⱼ₌₀ⁱ⁻¹Mⱼ+m.

In another example A2.13.2, M₀=M₁= . . . =M_{K-1}=M, i.e., the number of reference signals in each entity is the same. m is the resourceID of a reference signal within entity i. The resourceID of reference signal m in entity i can be given by: resourceId(m, i)=M·i+m.

In another example A2.13.3, M₀, M₁, . . . , Mᵢ, M_{K-1} can be different for each entity i. m is the resourceID of a reference signal within entity i. Mₘₐₓ=max(M₀, M₁, . . . , M_{K-1}). The resourceID of reference signal m in entity i can be given by: resourceId(m, i)=Mₘₐₓ·i+m.

FIG. 35, illustrates an example of inclusion of the resourceID of example A2.13.1, A2.13.2, or A2.13.3 in the TCI state. FIG. 35 only shows the IEs of interested, other IEs are not shown.

resourceId(m, i) of examples A2.13.1, A2.13.2, and A2.13.3 and FIG. 35, can be for one of the following reference signals: (1) SSB; (2) NZP CSI-RS; or (3) SRS.

In one example A2.14, a source RS within a TCI state includes two separate indices; a first index of a source RS for a first entity (e.g., for a serving cell or a first TRP), and a second index of a source RS for a second entity (e.g., a cell with a PCI different from the PCI of the serving cell or a second TRP). As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

In one example A2.14.1, for the SSBsource RS the SSB includes two fields: (1) the SSB-Index within a first entity (e.g., for a serving cell or a first TRP); and (2) the SSB-Index within a second entity (e.g., a cell with a PCI different from the PCI of the serving cell or a second TRP).

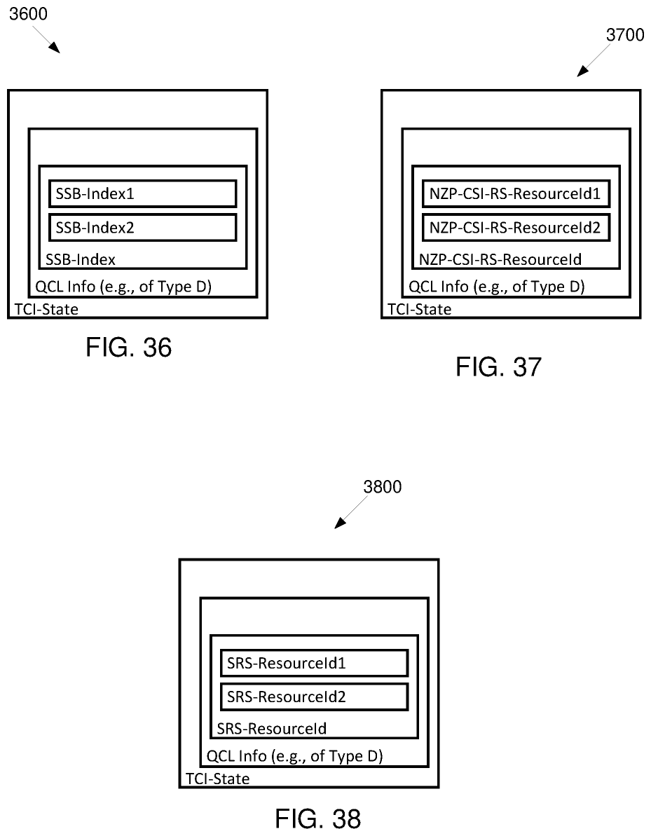

FIG. 36 illustrates another example of QCL-Info 3600 according to embodiments of the present disclosure. An embodiment of the QCL-Info 3600 shown in FIG. 36 is for illustration only.

An example for illustration is shown in FIG. 36 for SSB-Index, there are two entries one for the first entity (e.g., for a serving cell or a first TRP) and a second for a second entity (e.g., a cell with a PCI different from the PCI of the serving cell or a second TRP):

| SSB-Index ::= SEQUENCE { | |
|---|---|
| ssb | SSB-Index1 |
| ssb | SSB-Index2 |
| }. | |

In another example A2.14.2, for the NZP-CSI-RS source RS the NZP-CSI-RS includes two fields: (1) the NZP-CSI-RS-ResourceId within a first entity (e.g., for a serving cell or a first TRP); and (2) the NZP-CSI-RS-ResourceId within a second entity (e.g., a cell with a PCI different from the PCI of the serving cell or a second TRP).

An example for illustration is shown in FIG. 37 for NZP-CSI-RS-ResourceId, there are two entries one for the first entity (e.g., for a serving cell or a first TRP) and a second for a second entity (e.g., a cell with a PCI different from the PCI of the serving cell or a second TRP):

| NZP-CSI-RS-ResourceId-PCI ::= SEQUENCE { | |
|---|---|
| NZP-CSI-RS | NZP-CSI-RS-ResourceId1 |
| NZP-CSI-RS | NZP-CSI-RS-ResourceId2 |
| }. | |

FIG. 37 illustrates yet another example of QCL-Info 3700 according to embodiments of the present disclosure. An embodiment of the QCL-Info 3700 shown in FIG. 37 is for illustration only.

In another example A2.14.3, for the SRS source RS the SRS includes two fields: (1) the SRS-ResourceId within a first entity (e.g., for a serving cell or a first TRP); and (2) the SRS-ResourceId within a second entity (e.g., a cell with a PCI different from the PCI of the serving cell or a second TRP).

An example for illustration is shown in FIG. 38 for SRS-ResourceId, there are two entries one for the first entity (e.g., for a serving cell or a first TRP) and a second for a second entity (e.g., a cell with a PCI different from the PCI of the serving cell or a second TRP):

| SRS-ResourceId ::= SEQUENCE { | |
|---|---|
| SRS | SRS-ResourceId1 |
| SRS | SRS-ResourceId1 |
| }. | |

FIG. 38 illustrates yet another example of QCL-Info 3800 according to embodiments of the present disclosure. An embodiment of the QCL-Info 3800 shown in FIG. 38 is for illustration only.

In another example A2.14.4, a first source RS of a first entity is of a different type than a second source RS of a second entity. For example, the first source RS can be SSB, and the second source RS can be NZP-CSI-RS. The first source RS can be SSB, and the second source RS can be SRS. The first source RS can be NZP-CSI-RS, and the second source RS can be SSB. The first source RS can be NZP-CSI-RS, and the second source RS can be SRS. The first source RS can be SRS, and the second source RS can be SSB. The first source RS can be SRS, and the second source RS can be NZP-CSI-RS.

In one example A2.14.5, source RS for two entities are configured K=2, e.g., a first entity is a serving cell, and a second entity is a cell with a PCI different from the PCI of the serving cell, or a first entity is a first TRP, and a second entity is a second TRP.

In another example A2.14.6, source RS from more than two entities are configured K≥2.

In one example A2.14.6.1, the index or identity of the first and second entities to use for determining the source RS of each entity is further configured by RRC.

In another example A2.14.6.2, the index or identity of the first entity (e.g., serving cell or a first TRP) is configured by RRC and the index or identity of the second entity (e.g., cell with a PCI different from the PCI of the serving cell or a second TRP) is determined by a MAC CE message. The MAC CE message can be the message activating the TCI states or a separate message.

In another example A2.14.6.3, the index or identity of the second entity (e.g., cell with a PCI different from the PCI of the serving cell or a second TRP) is configured by RRC and the index or identity of the first entity (e.g., serving cell or a first TRP) is determined by a MAC CE message. The MAC CE message can be the message activating the TCI states or a separate message.

In one example A2.14.6.4, the index or identity of the first and second entities to use for determining the source RS of each entity is further determined by a MAC CE message. The MAC CE message can be the message activating the TCI states or a separate message. The index or identity of the first and second entities can be determined by the same MAC CE message or by different MAC CE messages.

In one example A2.14.7, the UE is configured with 2 CORESETPoolIndex values (e.g., CORESETPoolIndex #0 and CORESETPoolIndex #1). The source RS of the first entity is associated with a first CORESETPoolIndex (e.g., CORESETPoolIndex #0), and the source RS of the second entity is associated with a second CORESETPoolIndex (e.g., CORESETPoolIndex #1).

In another example A2.14.7a, the UE is configured with 2 CORESETs e.g., for UE dedicated channels. The source RS of the first entity is associated with a first CORESET, and the source RS of the second entity is associated with a second CORESET.

In another example A2.14.8, the UE is configured with 1 CORESETPoolIndex (or a CORESET for UE dedicated channels). A MAC CE and/or RRC signaling further determines which source RS (the first source RS or the second source RS) to use for CORESET and the unified (master or main) TCI state. e.g., a one-bit flag can determine the first source RS (e.g., logical 0) or the second source RS (e.g., logical 1) or vice versa. The MAC CE message can be the message activating the TCI states or a separate message. The unified (master or main) TCI state is TCI state of UE-dedicated reception on PDSCH/PDCCH or dynamic-grant/configured-grant based PUSCH and all of dedicated PUCCH resources.

In a variant of example A2.14.8, a per-determined (e.g., specified in the system specification) source RS can be used for the CORESETPoolIndex (or CORESET for UE dedicated channels), for example this can be: (1) the first or second the source RS as specified in the system specifications; and (2) the source RS with the lowest (or highest) ID.

In a variant of example A2.14.8, a DCI further determines which source RS (the first source RS or the second source RS) to use for CORESETPoolIndex (or CORESET for UE dedicated channels) after a beam application time. e.g., a one-bit flag in the DCI can determine the first source RS (e.g., logical 0) or the second source RS (e.g., logical 1) or vice versa. The DCI can be the DCI used for beam indication (e.g., the DCI that carriers the indicated TCI state(s)).

In another example A2.14.9, the UE is configured with a CORESET having a TCI state with two source RS, e.g., a first source RS associated with a first entity (e.g., for a serving cell or a first TRP) and a second source RS associated with a second entity (e.g., for a cell with a PCI different from the PCI of the serving cell or a second TRP). A PDCCH candidate in the CORESET has the PDCCH DMRS associated with the two source RS in all resource element groups (REGs)/control channel elements (CCEs) of the PDCCH. This can be an example of a single frequency network (SFN).

In one example, the first source RS is also used to receive a PSDCH from the first entity, and the second source RS is also used to receive a PDSCH from the second entity. In another example, the two source RS are used to receive a PDSCH from the two entities, in this case, the PDSCH DMRS is associated with the two source RS.

In another example A2.14.10, the UE is configured with at least two search space sets (e.g., for UE dedicated channels), a first search space set is associated with a first CORESET and a second search space set is associated with a second CORESET. The first CORESET is associated with a first source RS of the unified (or main or master) TCI state, wherein the first source RS is associated with a first entity (e.g., for a serving cell or a first TRP). The second CORESET is associated with a second source RS of unified (or main or master) TCI state, wherein the second source RS is associated with a second entity (e.g., for a cell with a PCI different from the PCI of the serving cell or a second TRP). A first PDCCH is transmitted in the first Search Space set/CORESET.

A second PDCCH is transmitted in the second Search Space set/CORESET. The first PDCCH and the second PDCCH are repetitions of one another, i.e., the encoding/rate matching is based on one repetition, and the same coded bits are repeated for the other repetition. Each repetition has the same number of CCEs and the coded bits correspond to the same DCI payload. The first PDCCH and the second PDCCH are linked.

In one example, the first and second PDCCH are time division multiplexed (TDM). Two sets of symbols of the PDCCHes in non-overlapping time intervals are transmitted, wherein each set of symbols is associated with a TCI state of an entity. In one example, the non-overlapping symbols can be in a same slot. In another example, the non-overlapping symbols are in different slots.

In another example, the first and second PDCCH are frequency division multiplexed (FDM). Two sets of REG bundles/CCEs of the PDCCHes in non-overlapping frequencies are transmitted, wherein each set of REG bundles/CCEs is associated with a TCI state of an entity.

In a variant example of example A2.14.10, each PDCCH can have a different payload, for example, the payload of the first PDCCH can include scheduling information (UL and/or DL) of a first entity, while the payload of the second PDCCH can include scheduling information (UL and/or DL) of a second entity.

In one example A2.15, CSI-RS resource is configured as a target reference signal of a TCI state associated or quasi-co-located with an SSB of an entity. In one example, the entity can be a PCI that is different from the PCI of the serving cell. For example, the CSI-RS resource is from a pool (list) of CSI-RS resources across all entities (e.g., as described in example 1.3), and the SSB is an SSB associated with an entity (e.g., as described in example 1.1).

In one example A2.15.1, the CSI-RS resource is a CSI-RS for tracking referred to as TRS. The TRS can be a NZP CSI-RS-Resource configured with higher layer parameter trs-info. The TRS can be a NZP CSI-RS-Resource in a NZP CSI-RS-ResourceSet configured with higher layer parameter trs-info.

In one example A2.15.1.1, the TRS has a QCL-Type-C relation with an SSB associated with PCI different from the PCI of the serving cell.

In one example A2.15.1.2, the TRS has a QCL-Type-D relation with an SSB associated with PCI different from the PCI of the serving cell.

In one example A2.15.1.3, the TRS has a QCL-Type-C and QCL-Type-D relation with an SSB associated with PCI different from the PCI of the serving cell.

In one example A2.15.1.4, the TRS has a QCL-Type-C relation with an SSB associated with PCI different from the PCI of the serving cell, and a QCL-Type-D relation with CSI-RS resource for beam management (see example A2.15.2).

In one example A2.15.1.5, the TRS has a QCL relation (e.g., Type-A and/or Type-D) to a second CSI-RS, and the second CSI-RS has a QCL relation (e.g., Type-A or Type-B or Type-C or Type-D) to an SSB associated with a PCI different from the PCI of the serving cell.

In one example A2.15.1.6, the TRS has a QCL relation (e.g., Type-A and/or Type-D) to a second CSI-RS, and the second CSI-RS is directly or indirectly associated through a QCL relation with an SSB associated with a PCI different from the PCI of the serving cell. Indirect QCL association with an SSB is association through a chain of CSI-RS resources with at least one other CSI-RS resource that is eventually QCL-associated with an SSB.

In one example A2.15.1.7, when the TRS has a QCL relation with two reference signals, the two reference signals have direct or indirect QCL relation to SSB(s) associated with the same PCI that can be the same or different from the PCI of the serving cell.

In one example A2.15.2, the CSI-RS resource is a CSI-RS for beam management referred to as CSI-RS for BM. The CSI-RS for BM can be a NZP CSI-RS-Resource configured with higher layer parameter repetition. The CSI-RS for BM can be a NZP CSI-RS-Resource in a NZP CSI-RS-ResourceSet configured with higher layer parameter repetition.

In one example A2.15.2.1, the CSI-RS for BM has a QCL-Type-C relation with an SSB associated with PCI different from the PCI of the serving cell.

In one example A2.15.2.2, the CSI-RS for BM has a QCL-Type-D relation with an SSB associated with PCI different from the PCI of the serving cell.

In one example A2.15.2.3, the CSI-RS for BM has a QCL-Type-C and QCL-Type-D relation with an SSB associated with PCI different from the PCI of the serving cell.

In one example A2.15.2.4, the CSI-RS for BM has a QCL relation (e.g., Type-A and/or Type-D) to a second CSI-RS, and the second CSI-RS has a QCL relation (e.g., Type-A or Type-B or Type-C or Type-D) to an SSB associated with a PCI different from the PCI of the serving cell.

In one example A2.15.2.5, the CSI-RS for BM has a QCL relation (e.g., Type-A and/or Type-D) to a second CSI-RS, and the second CSI-RS is directly or indirectly associated through a QCL relation with an SSB associated with a PCI different from the PCI of the serving cell. Indirect QCL association with an SSB is association through a chain of CSI-RS resources with at least one other CSI-RS resource that is eventually QCL-associated with an SSB.

In one example A2.15.2.6 when the CSI-RS for BM has a QCL relation with two reference signals, the two reference signals have direct or indirect QCL relation to SSB(s) associated with the same PCI that can be the same or different from the PCI of the serving cell.

In one example A2.15.3, the CSI-RS resource is a CSI-RS for CSI acquisition referred to as CSI-RS for CSI. The CSI-RS for CSI can be a NZP CSI-RS-Resource configured without higher layer parameter trs-info and without higher layer parameter repetition. The CSI-RS for CSI can be a NZP CSI-RS-Resource in a NZP CSI-RS-ResourceSet configured without higher layer parameter trs-info and without higher layer parameter repetition.

In one example A2.15.3.1, the CSI-RS for CSI has a QCL-Type-D relation with an SSB associated with PCI different from the PCI of the serving cell, and a QCL-Type-A relation with a TRS.

In one example A2.15.3.2, the CSI-RS for CSI has a QCL relation (e.g., Type-A and/or Type-D) to a second CSI-RS, and the second CSI-RS has a QCL relation (e.g., Type-A or Type-B or Type-C or Type-D) to an SSB associated with a PCI different from the PCI of the serving cell.

In one example A2.15.3.3, the CSI-RS for CSI has a QCL relation (e.g., Type-A and/or Type-D) to a second CSI-RS, and the second CSI-RS is directly or indirectly associated through a QCL relation with an SSB associated with a PCI different from the PCI of the serving cell. Indirect QCL association with an SSB is association through a chain of CSI-RS resources with at least one other CSI-RS resource that is eventually QCL-associated with an SSB.

In one example A2.15.3.4, when the CSI-RS for CSI has a QCL relation with two reference signals, the two reference signals have direct or indirect QCL relation to SSB(s) associated with the same PCI that can be the same or different from the PCI of the serving cell.

In the present disclosure, the source reference signal of a TCI state is only identified by its resource ID within an entity as illustrated in FIG. 21 or a resource ID common across all entities as illustrated in FIG. 22. To determine the entity of the source reference signal when applying the resource reference signal of a TCI state, the index of entity can be determined by: (1) implicitly by the TCI state ID (e.g., the group of the TCI state ID); (2) the configuration of a target reference signal; and/or (3) the MAC CE activating TCI states.

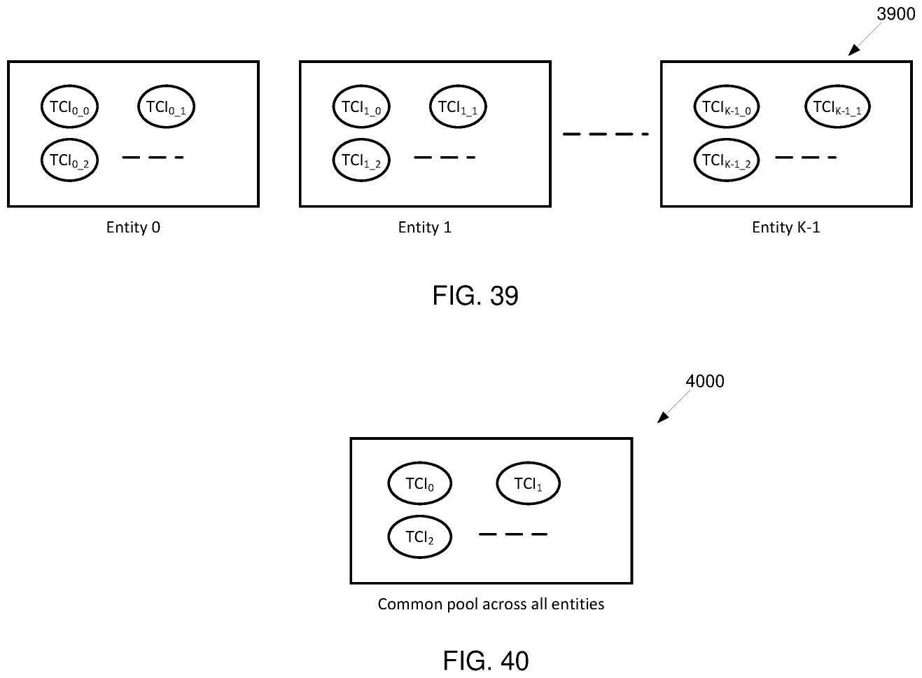

The TCI states/TCI state IDs can be partitioned into K groups, corresponding to the K entities as illustrated in FIG. 39. The association of a TCI state/TCI state ID to an entity is according to the association of the corresponding source RS to that entity.

FIG. 39 illustrates an example of TCI states/TCI state IDs for K groups 3900 according to embodiments of the present disclosure. An embodiment of the TCI states/TCI state IDs for K groups 3900 shown in FIG. 39 is for illustration only.

Alternatively, the TCI states/TCI state IDs list can be a common pool across all entities as illustrated in FIG. 40.

FIG. 40 illustrates an example of TCI states/TCI state IDs for a common pool across all entities 4000 according to embodiments of the present disclosure. An embodiment of the TCI states/TCI state IDs for a common pool across all entities 4000 shown in FIG. 40 is for illustration only.

In one example A3.1, the maximum number of configured entities K (see FIG. 24) can depend on a UE capability and/or can be specified in the system specifications. An entity can be a cell with a PCI. The number of entities K can be configured and/or updated by RRC signaling and/or MAC CE signaling. The identities of the configured entities can be configured by RRC signaling and/or MAC CE signaling. For example, identity of an entity can be the PCI of the entity. A list of up to K PCIs is configured, e.g., {PCI₀, PCI₁, . . . , PCI_{K-1}}, the entity index can be the order (position) of the entity in the list, or it can be separately configured as shown in FIG. 27. For an entity with index i within the list and physical cell identity PCIᵢ, the number of TCI states configured is Mᵢ.

As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

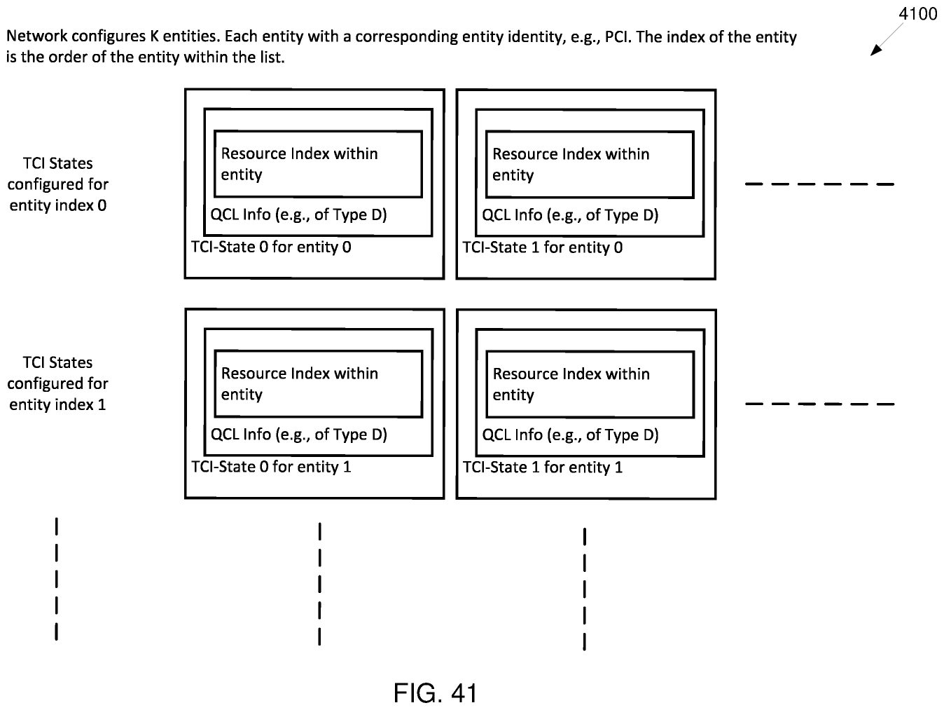

FIG. 41 illustrates an example of entity index for the reference signal 4100 according to embodiments of the present disclosure. An embodiment of the entity index for the reference signal 4100 shown in FIG. 41 is for illustration only.

The source reference signal (e.g., SSB, CSI-RS or SRS) in the TCI state includes a resource ID of the reference signal within an entity (e.g., SSB-Index, or NZP-CSI-RS-ResourceId, or SRS-ResourceId). The entity index for the reference signal is determined by the group of the TCI state as illustrated in FIG. 41. FIG. 41 only shows the IEs of interested, other IEs are not shown.

In one example A3.2, the maximum number of entities configured is K. Out of the K entities, L entities can have activated TCI states, this is denoted as the activated list. Wherein, L can depend on a UE capability and/or can be specified in the system specifications. An entity can be a cell with a PCI. The number of entities L can be configured and/or updated by RRC signaling and/or MAC CE signaling. The identities of the configured entities can be configured by RRC signaling and/or MAC CE signaling. For example, identity of an entity can be the PCI of the entity. A list of up to L PCIs is configured in the activated list, e.g., {PCI₀, PCI₁, . . . , PCI_{L-1}}, the entity index can be the order (position) of the entity in the list, or it can be separately configured as shown in FIG. 31. For an entity with index i within the list and physical cell identity PCIᵢ, the number of TCI states configured is Mᵢ.

As described earlier, the TCI state includes one or two QCL Info IEs. The QCL Info IE includes at least the QCL Type and source reference signal. When the QCL Type is Type D or spatial relation source reference signal, the source reference signal can be one of: (1) SSB; (2) NZP CSI-RS; or (3) SRS.

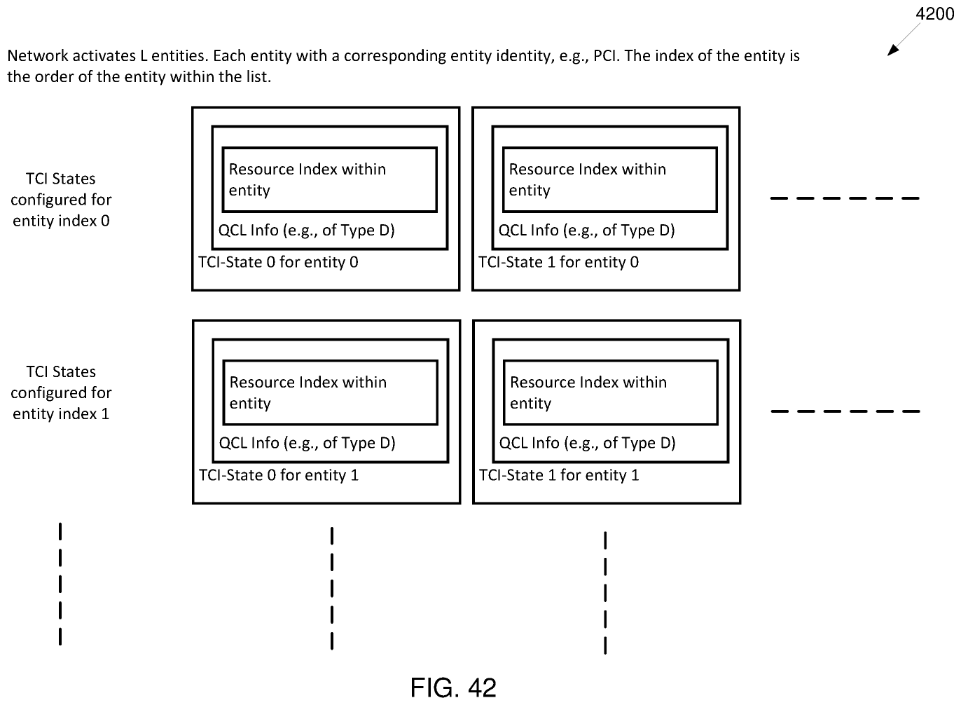

FIG. 42 illustrates another example of entity index for the reference signal 4200 according to embodiments of the present disclosure. An embodiment of the entity index for the reference signal 4200 shown in FIG. 42 is for illustration only.

The source reference signal (e.g., SSB, CSI-RS or SRS) in the TCI state includes a resource ID of the reference signal within an entity (e.g., SSB-Index, or NZP-CSI-RS-ResourceId, or SRS-ResourceId). The entity index for the reference signal is determined by the group of the TCI state as illustrated in FIG. 42. FIG. 42 only shows the IEs of interested, other IEs are not shown.

In one example A3.3, the source reference signal (e.g., SSB, CSI-RS or SRS) in the TCI state includes a resource ID of the reference signal within an entity (e.g., SSB-Index, or NZP-CSI-RS-ResourceId, or SRS-ResourceId). The TCI state is used in the configuration of target reference signal. For example, the target reference signal can be a NZP CSI-RS (e.g., TRS, or CSI-RS for beam management, or CSI-RS for acquisition). In another example, the target reference signal be an SRS.

In one example A3.3.1, the configuration of the target reference signal includes at least: (1) the TCI state, wherein the TCI state includes the resource index of the source reference signal within an entity; or (2) the entity index (cf. FIG. 27) or the entity identity (e.g., PCI) for the TCI state and the source reference signal.

In another example A3.3.2, the configuration of a resource set of the target reference signal includes at least: (1) the TCI state, wherein the TCI state includes the resource index of the source reference signal within an entity; or (2) the entity index (cf. FIG. 27) or the entity identity (e.g., PCI) for the TCI state and the source reference signal.

In one example A3.4, the source reference signal (e.g., SSB, CSI-RS or SRS) in the TCI state includes a resource ID of the reference signal within an entity (e.g., SSB-Index, or NZP-CSI-RS-ResourceId, or SRS-ResourceId). The TCI state is activated by a MAC CE. The MAC CE activating the TCI state includes the entity index (cf. FIG. 27) or the entity identity (e.g., PCI) for the TCI state and the source reference signal.

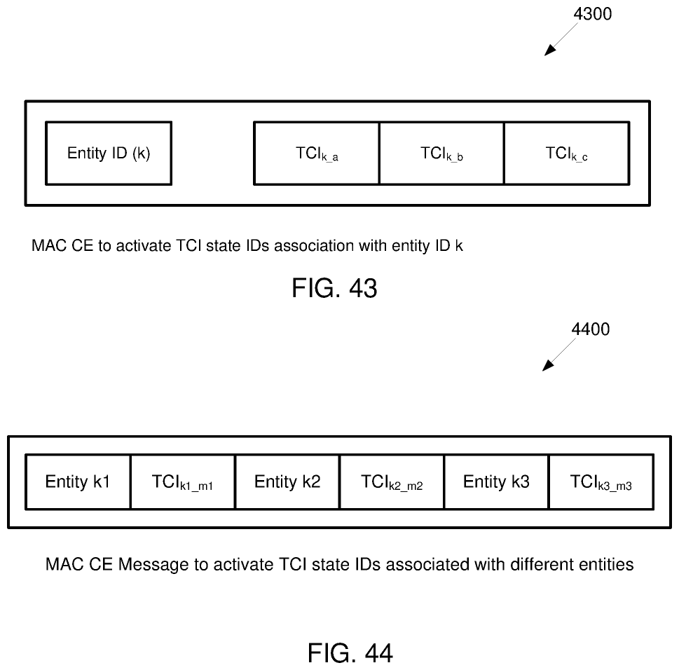

In one example A3.4.1, the MAC CE activation message, activates TCI states/TCI state IDs belonging to a same entity. As an example, a MAC CE activation message can include an entity ID and an ID for each TCI state/TCI state ID being activated within that entity as illustrated in FIG. 43. In one example, the activated TCI states of an entity belong to the same TCIStatePoolIndex.

FIG. 43 illustrates an example of MAC CE activation message 4300 according to embodiments of the present disclosure. An embodiment of the MAC CE activation message 4300 shown in FIG. 43 is for illustration only.

For example, an entity can be a cell (e.g., a PCI), the network configures a first TCIStatePoolIndex and a second TCIStatePoolIndex, the activated TCI states of a first PCI (e.g., a serving cell PCI) are activated for (or associated with) the first TCIStatePoolIndex, while the activated TCI states of a second PCI (e.g., a neighboring cell PCI) are activated for (or associated with) the second TCIStatePoolIndex. In another example, an entity can be a TRP, the network configures a first TCIStatePoolIndex and a second TCIStatePoolIndex, the activated TCI states of a first TRP are activated for (or associated with) the first TCIStatePoolIndex, while the activated TCI states of a second TRP are activated for (or associated with) the second TCIStatePoolIndex.

In another example, the activated TCI states/TCI state IDs can be expressed as a bitmap with one bit for each TCI state/TCI state ID configured for that entity. A value of 1 in a bit is used to indicate the corresponding TCI state ID is active.

In another example A3.4.2, MAC CE activates TCI states/TCI state IDs belonging to different entities. In one example, the activated TCI states of an entity belong to the same TCIStatePoolIndex.

In one example A3.4.2.1, each activated TCI state/TCI state ID includes an entity ID and a TCI state ID within the entity. This is illustrated by way of example in FIG. 44.

FIG. 44 illustrates another example of MAC CE activation message 4400 according to embodiments of the present disclosure. An embodiment of the MAC CE activation message 4400 shown in FIG. 44 is for illustration only.

In another example A3.4.2.2, the activated TCI states/TCI state IDs can be expressed as a bitmap with one bit for each configured (or activated) entity with its associated TCI state/TCI state ID. Wherein, the TCI state IDs configured (or activated) are arranged within the bitmap first in order within each entity and then in order across entities. A value of 1 in a bit is used to indicate the corresponding TCI state ID is active.

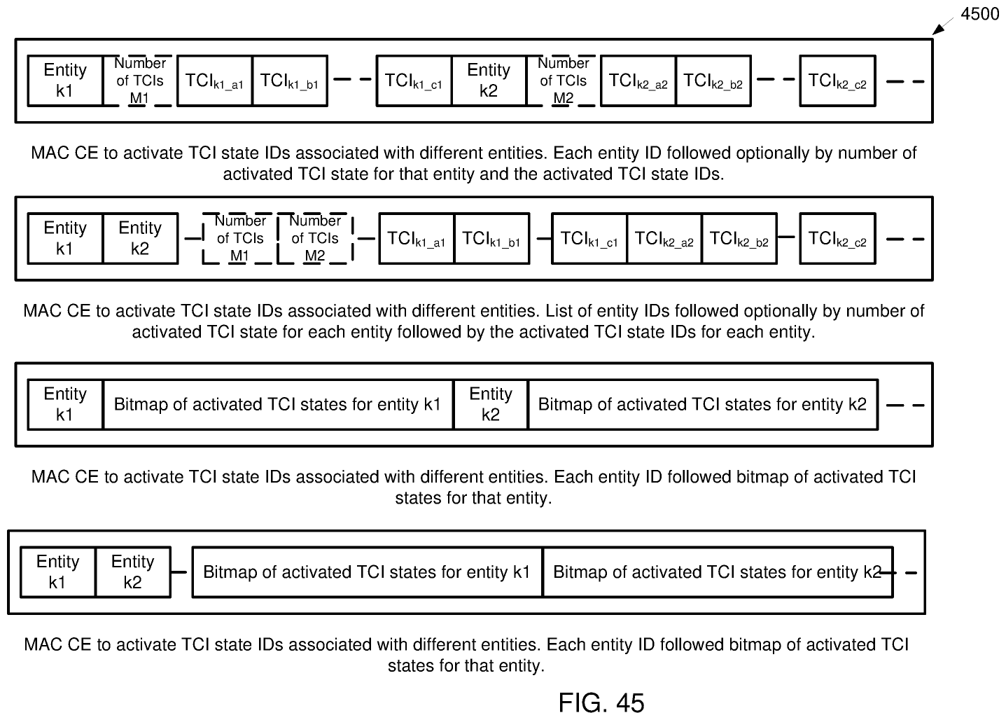

In another example A3.4.2.3, the MAC CE activation message includes one or more entity IDs, each entity ID includes one or more TCI states/TCI state IDs for that entity. This illustrated by way of examples in FIG. 45.

FIG. 45 illustrates yet another example of MAC CE activation message 4500 according to embodiments of the present disclosure. An embodiment of the MAC CE activation message 4500 shown in FIG. 45 is for illustration only.

In one example, associated with each entity ID is the number of TCI states/TCI state IDs being activated. The number of activated TCI states/TCI state IDs for each entity can be different. This is illustrated by the top two figures of FIG. 45, with the number of TCIs for each entity included in the MAC CE.

In another example, the number of activated TCI states/TCI state IDs for each entity is the same. This is illustrated by the top two figures of FIG. 45, with the number of TCIs for each entity NOT included in the MAC CE, but the number of TCIs can be included as a separate field common to all entities, or configured by RRC signaling or specified in system specifications.

In one example, the activated TCI states for each entity is provided by a bitmap, with one bit corresponding to each entity configured by RRC. A value of 1 in a bit is used to indicate the corresponding TCI state ID is active. This is illustrated by the lower two figures of FIG. 45.

In another example, the activated TCI states for each entity is a list of TCI states being activated. This is illustrated by the top two figures of FIG. 45.

In another example A3.4.3, a first MAC CE activates a subset of entities. A second MAC CE activates TCI states/TCI state IDs within the activated entities. In one example, each entity within the subset of entities is associated with a CORESETPoolIndex. In one example, a CORESETPoolIndex can be associated with one entity only.

In one example, the first MAC CE can activate any of the entities configured by RRC. In another example, the entities configured by RRC are divided into two subsets. A first subset of entities, which includes entities that are always activated and do not need MAC CE activation (for example this can correspond to serving cell(s)), a second subset of entities that can be activated or deactivated by MAC CE (for example this can correspond to cells with a PCI different from that of the serving cell).

In one example A3.4.3.1, second MAC CE for each activated TCI state/TCI state ID includes an entity ID and a TCI state ID within the entity ID. The entity ID can be one of: (1) the entity ID configured by RRC signaling; or (2) the order of the entity ID activated by RRC signaling (always activated entities—if applicable), and MAC CE signaling.

In another example A3.4.3.2, the second MAC CE for the activated TCI states/TCI state IDs can be expressed as a bitmap with one bit for each configured TCI state/TCI state ID of the activated entities. Wherein, the TCI state IDs configured are arranged within the bitmap first in order within each entity and then in order across the activated entities. A value of 1 in a bit is used to indicate the corresponding TCI state ID is active.

In another example A3.4.3.3, the second MAC CE includes one or more entity IDs corresponding to the activated MAC CE entities, each entity ID includes one or more TCI states/TCI state IDs for that entity. The entity ID can be one of: (1) the entity ID configured by RRC signaling; or (2) the order of the entity ID activated by RRC signaling (e.g., always activated entities—if applicable), and MAC CE signaling.

In one example, associated with each MAC CE entity ID is the number of TCI states/TCI state IDs being activated. The number of activated TCI states/TCI state IDs for each entity can be different.

In another example, the number of activated TCI states/TCI state IDs for each entity is the same. The number of TCIs can be included as a separate field common to all entities in the second MAC CE or in the first MAC CE, or configured by RRC signaling or specified in system specification.

In one example, the activated TCI states for each entity is provided by a bitmap, with a bitmap corresponding to the configured TCI states/TCI state IDs of each activated MAC CE. A value of 1 in a bit is used to indicate the corresponding TCI state ID is active.

In another example, the activated TCI states for each entity is a list of TCI states being activated.

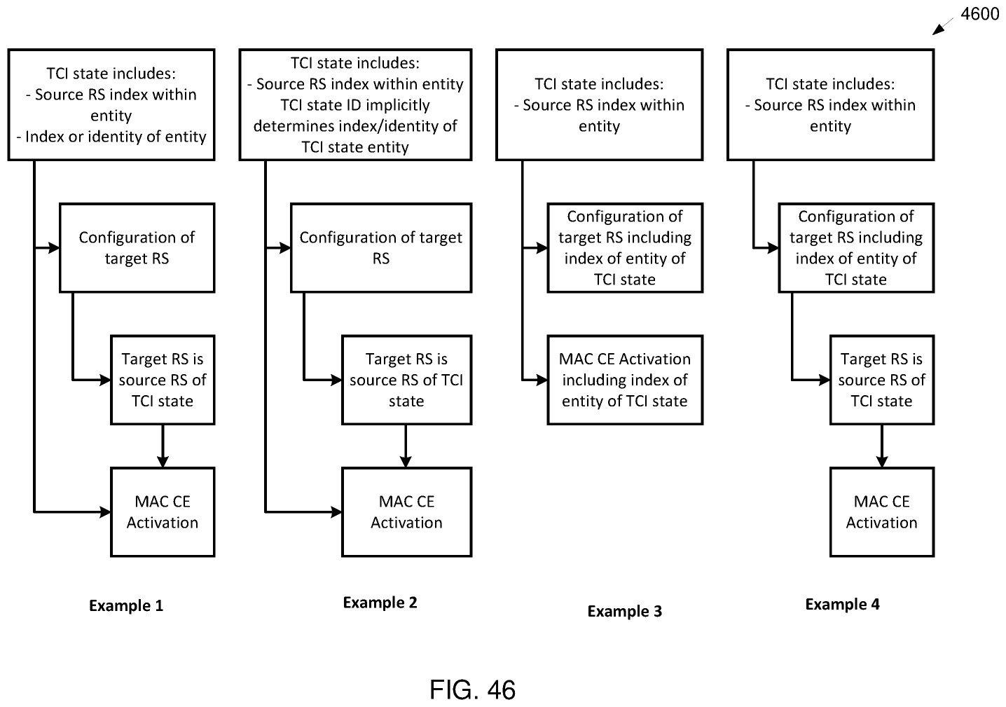

FIG. 46 illustrates yet another example of MAC CE activation message 4600 according to embodiments of the present disclosure. An embodiment of the MAC CE activation message 4600 shown in FIG. 46 is for illustration only.

In example A1, the configuration of the TCI state includes the index of the source RS within an entity and the index or identity (e.g., PCI) of an entity the source RS belongs to. The TCI state can be used: (1) to configure a target RS, which itself can become a source RS of another TCI state; and (2) as an activated TCI state (e.g., by MAC CE activation).

As the source RS is determined in the TCI state, no further configuration or indication is required when configuring a target RS or when activating a MAC CE.

In example A2, the configuration of the TCI state includes only an index of the source RS within an entity as illustrated in FIG. 21 or a resource ID common across all entities as illustrated in FIG. 22. The entity of the source RS is determined implicitly based on the TCI state ID (e.g., based on grouping of TCI state IDs). The TCI state can be used: (1) to configure a target RS, which itself can become a source RS of another TCI state; and (2) as an activated TCI state (e.g., by MAC CE activation).

As the source RS is determined in the TCI state and with the TCI state ID, no further configuration or indication is required when configuring a target RS or when activating a MAC CE.

In example A3, the configuration of the TCI state includes only the index of the source RS within an entity. The TCI state can be used: (1) to configure a target RS. The configuration of the target RS also includes the entity index for determining the source RS of the TCI state; and (2) as an activated TCI state (e.g., by MAC CE activation). The MAC CE activation also includes the entity index for determining the source RS of the TCI state.

As only the source RS is determined in the TCI state, additional configuration or indication of the entity index is required when configuring a target RS or when activating a MAC CE.

In example A4, the configuration of the TCI state includes only the index of the source RS within an entity. The TCI state can be used to configure a first target RS. The configuration of the target RS also includes the entity index for determining the source RS of the TCI state.

As only the source RS is determined in the TCI state, additional configuration or indication of the entity index is required when configuring a target RS.

The target RS can become a source RS for another TCI state. When that TCI state is used for configuring a second target RS, or when it used for MAC CE activation, no further configuration or indication is required to determine the entity index, as this has already been determined when configuring the first target RS.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive or transmit on K>1 entities,
receive configuration information for a first list of reference signals (RSs), wherein a RS in the first list is identified by an index within an entity and an index or identifier of the entity,
receive configuration information for a second list of RSs, wherein a RS in the second list is identified by a common index across the K>1 entities,
receive configuration information for a list of transmission configuration indication (TCI) states, wherein a source RS of a TCI state in the list of TCI states is from the first list of RSs or the second list of RSs,
receive an indication of activated TCI state code points via a medium access control-control element (MAC CE), and
receive a downlink control information (DCI) indicating at least one of the activated TCI state code points; and
a processor operably coupled to the transceiver, the processor configured to:
determine a TCI state to apply based on the at least one activated TCI state code point indicated by the DCI,
determine an entity of the determined TCI state and a source RS of the determined TCI state, and
update spatial filters for downlink (DL) channels or uplink (UL) channels based on the determined source RS,
wherein the transceiver is further configured to receive or transmit the DL channels or the UL channels of the determined entity, respectively, based on the updated spatial filters.

2. The UE of claim 1, wherein an entity is a cell or a group of cells with a physical cell identity (PCI).

3. The UE of claim 1, wherein the first list of RSs includes at least synchronization signals and physical broadcast channel blocks (SSBs).

4. The UE of claim 1, wherein the second list of RSs includes at least a non-zero power channel state information reference signal (NZP CSI-RS).

5. The UE of claim 1, wherein:
the activated TCI state code points correspond to only one entity at a time,
the activated TCI state code points are first activated TCI state code points that correspond to a first entity,
second activated TCI state code points are indicated via a MAC CE for a second entity,
one of the second activated TCI state code points is an indicated TCI state code point, and
the processor is further configured to, after a beam application delay:
identify that the first activated TCI state code points for the first entity are deactivated,
identify that the second activated TCI state code points for the second entity are activated, and
determine to apply the indicated TCI state code point from the second activated TCI state code points for the second entity.

6. The UE of claim 1, wherein a RS is configured as a target RS of a TCI state with a source RS from the first list.

7. The UE of claim 1, wherein:
the MAC CE indicating the activated TCI state code points includes a cell radio network temporary identifier (C-RNTI) for entities with activated TCI states, and
when applying the determined TCI state, the transceiver is further configured to use the C-RNTI associated with the determined entity associated with the determined TCI state.

8. A base station (BS), comprising:
a transceiver configured to:
receive or transmit on K>1 entities,
transmit configuration information for a first list of reference signals (RSs), wherein a RS in the first list is identified by an index within an entity and an index or identifier of the entity,
transmit configuration information for a second list of RSs, wherein a RS in the second list is identified by a common index across the K>1 entities,
transmit configuration information for a list of transmission configuration indication (TCI) states, wherein a source RS of a TCI state in the list of TCI states is from the first list of RSs or the second list of RSs, and
transmit an indication of activated TCI state code points via a medium access control-control element (MAC CE);
a processor operably coupled to the transceiver, the processor configured to:
determine a source RS and an associated entity, and
determine a TCI state code point to apply, based on the determined source RS and the associated entity, from the at least one activated TCI state code points,
wherein the transceiver is further configured to transmit a downlink control information (DCI) indicating the determined TCI state code point,
wherein the processor is further configured to update spatial filters for downlink (DL) channels or uplink (UL) channels based on the determined source RS, and
wherein the transceiver is further configured to transmit or receive the DL channels and the UL channels of the associated entity, respectively, based on the updated spatial filters.

9. The BS of claim 8, wherein an entity is a cell or a group of cells with a physical cell identity (PCI).

10. The BS of claim 8, wherein the first list of RSs includes at least synchronization signals and physical broadcast channel blocks (SSBs).

11. The BS of claim 8, wherein the second list of RSs includes at least a non-zero power channel state information reference signal (NZP CSI-RS).

12. The BS of claim 8, wherein:
activated TCI state code points on only one entity are supported at a same time,
the activated TCI state code points are first activated TCI state code points that correspond to a first entity,
second activated TCI state code points are indicated via a MAC CE are for a second entity,
one of the second activated TCI state code points is an indicated TCI state code point, and
after a beam application delay:
the first activated TCI state code points of the first entity become deactivated,
the second activated TCI state code points of the second entity become activated, and
the indicated TCI state code point from the second activated TCI state code points for the second entity is applied.

13. The BS of claim 8, wherein a RS is configured as a target RS of a TCI state with a source RS from the first list.

14. The BS of claim 8, wherein:
the MAC CE indicating the activated TCI state code points includes a cell radio network temporary identifier (C-RNTI) for entities with activated TCI states, and
when applying the determined TCI state, the transceiver is further configured to use the C-RNTI associated with the determined entity associated with the determined TCI state.

15. A method of operating a user equipment (UE), the method comprising:
receiving configuration information to receive or transmit on K>1 entities;
receiving configuration information for a first list of reference signals (RSs), wherein a RS in the first list is identified by an index within an entity and an index or identifier of the entity;
receiving configuration information for a second list of RSs, wherein a RS in the second list is identified by a common index across the K>1 entities;
receiving configuration information for a list of transmission configuration indication (TCI) states, wherein a source RS of a TCI state in the list of TCI states is from the first list of RSs or the second list of RSs;
receiving an indication of activated TCI state code points via a medium access control-control element (MAC CE);
receiving a downlink control information (DCI) indicating at least one of the activated TCI state code points;
determining a TCI state to apply based on the at least one activated TCI state code point indicated by the DCI;
determining an entity of the determined TCI state and a source RS of the determined TCI state;
updating spatial filters for downlink (DL) channels or uplink (UL) channels based on the determined source RS; and
receiving or transmitting the DL channels or the UL channels of the determined entity, respectively, based on the updated spatial filters.

16. The method of claim 15, wherein an entity is a cell or a group of cells with a physical cell identity (PCI).

17. The method of claim 15, wherein:
the first list of RSs includes at least synchronization signals and physical broadcast channel blocks (SSBs), and
the second list of RSs includes at least a non-zero power channel state information reference signal (NZP CSI-RS).

18. The method of claim 15, wherein:
the activated TCI state code points correspond to only one entity at a time,
the activated TCI state code points are first activated TCI state code points that correspond to a first entity,
second activated TCI state code points are indicated via a MAC CE are for a second entity,
one of the second activated TCI state code point is an indicated TCI state code point, and
the method further comprises, after a beam application delay:
identifying that the first activated TCI state code points for the first entity are deactivated,
identifying that the second activated TCI state code points for the second entity are activated, and
determining to apply the indicated TCI state code point from the second activated TCI state code points for the second entity.

19. The method of claim 15, wherein a RS is configured as a target RS of a TCI state with a source RS from the first list.

20. The method of claim 15, wherein:
the MAC CE indicating the activated TCI state code points includes a cell radio network temporary identifier (C-RNTI) for entities with activated TCI states, and
the method further comprises, when applying the determined TCI state, using the C-RNTI associated with the determined entity associated with the determined TCI state.
